(19) United States
(12) Patent Application Publication
(10) Pub. No.: US 2026/0288812 A1
(43) Pub. Date: Sep. 24, 2026

(54) SYSTEM

(71) Applicant: SoftBank Group Corp., Tokyo (JP)

(72) Inventor: Natsuki KODA, Chiyoda-ku, Tokyo (JP)

(73) Assignee: SoftBank Group Corp., Tokyo (JP)

(21) Appl. No.: 19/567,060

(22) Filed: Mar. 14, 2026

(30) Foreign Application Priority Data
Mar. 19, 2025 (JP) 2025-045136

(51) Int. Cl. G06F 16/3329; G06F 16/3332; G06F 16/334

(52) U.S. Cl. CPC G06F 16/33295; G06F 16/3335; G06F 16/3347

(57) ABSTRACT

A system includes a processor that is configured to provide an interface for receiving information from a user, generate a first prompt sentence by using a generative AI model for evaluating a degree of offensiveness of the received information, and generate a second prompt sentence by using a natural language generation technique for transforming the received information so that the degree of offensiveness becomes lower based on an evaluation result of the degree of offensiveness.

### CROSS-REFERENCE TO RELATED APPLICATION

This application is based on and claims priority under 35 USC 119 from Japanese Patent Application No. 2025-045136 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In user generated content (UGC) services and other interactive systems, users frequently submit textual information that may contain offensive, aggressive, or otherwise uncomfortable expressions. Conventional moderation approaches typically rely on rule-based filters, keyword lists, or offline human review. Such approaches are often insufficient in at least three respects. First, static keyword filters cannot accurately capture nuanced or context-dependent offensiveness, resulting in both false positives and false negatives. Second, blocking or deleting offensive information without transformation can harm user experience by interrupting communication or causing frustration for the user who submitted the information. Third, conventional systems do not flexibly adapt the expression of user information to a less offensive form while preserving the original intent, based on a quantitative evaluation of offensiveness. Accordingly, there is a need for a system that can automatically evaluate the degree of offensiveness of information received from a user and, when appropriate, transform the information into a less offensive form by using generative AI models and natural language generation techniques, while allowing non-offensive information to be presented as originally submitted.

### SUMMARY

In order to solve the above-described problems, the present invention provides a system comprising a processor, wherein the processor is configured to provide an interface for receiving information from a user, generate a first prompt sentence by using a generative AI model for evaluating a degree of offensiveness of the received information, and generate a second prompt sentence by using a natural language generation technique for transforming the received information so that the degree of offensiveness becomes lower based on an evaluation result of the degree of offensiveness. The processor is further configured to transform the received information based on the second prompt sentence generated by using the generative AI model when the evaluation result of the degree of offensiveness is equal to or greater than a predetermined threshold. The processor is also configured to present the received information without transformation based on the second prompt sentence generated by using the generative AI model when the evaluation result of the degree of offensiveness is equal to or less than a predetermined threshold. In this manner, the system automatically evaluates the offensiveness of user-submitted information and adaptively transforms only those portions whose offensiveness exceeds the predetermined threshold, thereby reducing the likelihood that other users will feel discomfort while maintaining the continuity and intent of communication.

The term “system” refers to an aggregate of hardware and software components including at least one processor and associated memory, interfaces, and programs, which cooperate to perform the functions described in the claims.

The term “processor” refers to one or more hardware processing units, such as a central processing unit (CPU), a graphics processing unit (GPU), a digital signal processor (DSP), or any combination thereof, that execute instructions to perform the operations specified in the claims.

The term “interface” refers to a hardware and/or software mechanism, such as a graphical user interface, an application programming interface (API), a web form, or a mobile application screen, through which information is received from a user.

The term “information” refers to data provided by a user through the interface, including at least textual content such as comments, messages, posts, or other user-generated text to be processed by the system.

The term “user” refers to a human operator who interacts with the system through the interface by submitting, viewing, or otherwise manipulating information.

The term “generative AI model” refers to a trained machine learning model, such as a neural network model including a large language model, that is configured to generate text or other content in response to input data or prompt sentences.

The term “prompt sentence” refers to a text string, command, instruction, or query that is supplied to a generative AI model or a natural language generation technique to guide or control the content and style of the output generated by the model or technique.

The term “degree of offensiveness” refers to a quantitative or qualitative measure indicating how likely the content of the information is to be perceived as offensive, aggressive, harmful, or uncomfortable by a reader, which may be represented as a score or a classification result.

The term “natural language generation technique” refers to a method or algorithm, including but not limited to a generative AI model, that automatically produces natural language text based on input data, prompt sentences, or context information.

The term “evaluation result” refers to data indicating the outcome of assessing the degree of offensiveness of the received information, such as a numerical score, a probability, or a categorical label derived from the generative AI model or an associated evaluation process.

The term “predetermined threshold” refers to a reference value or condition, set in advance by a system designer or operator, against which the evaluation result of the degree of offensiveness is compared in order to decide whether to transform the information.

The term “transform” refers to modifying, rewriting, or otherwise changing the textual content of the received information so that the degree of offensiveness is reduced while attempting to preserve at least part of the original meaning or intent.

The term “present” refers to outputting or displaying information to a user or another party through a user interface, display device, or communication channel, including the case where the original information is shown without transformation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

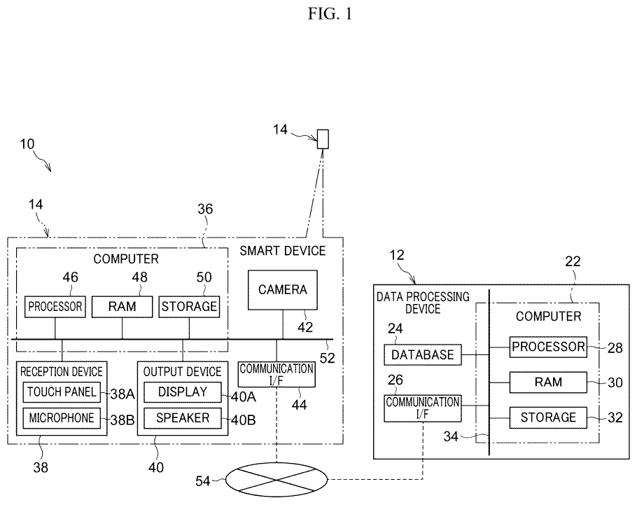

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

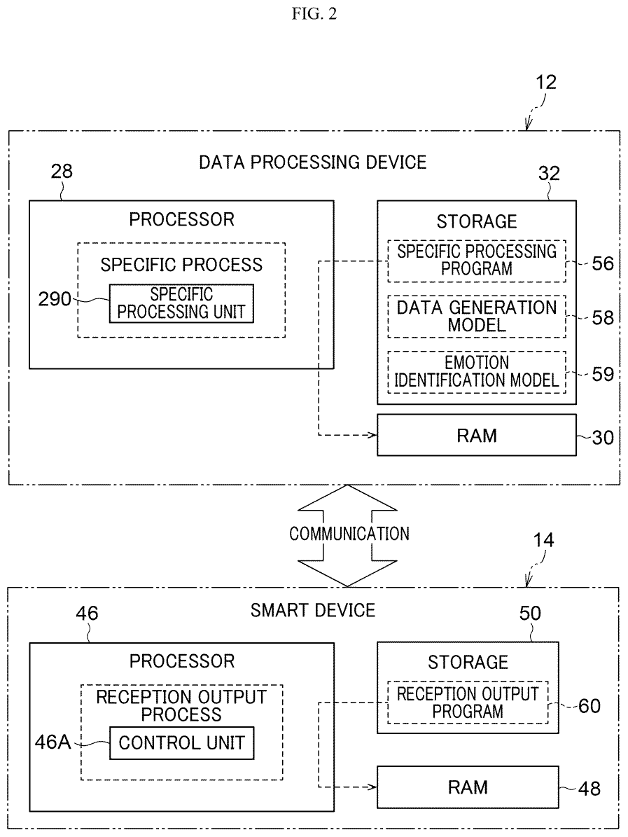

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional online platforms typically rely on rule-based filters or simple keyword lists to detect and handle user-generated content that may cause discomfort to other users. Such approaches suffer from several technical limitations. First, keyword-based filters often misclassify context-dependent expressions, either overblocking benign content or underblocking problematic content, because they do not exploit the semantic structure of full sentences. Second, once content is flagged, many systems either remove it or block it from display, which can degrade the continuity of conversation, cause user frustration, and reduce the informational value of the platform. Third, when natural language generation is employed to rewrite content, existing systems generally apply a fixed transformation without a tightly integrated feedback loop between a quantitative discomfort evaluation step and a controllable generative process. As a result, the transformed content may fail to sufficiently reduce discomfort, may alter the core meaning of the original text, or may introduce inconsistent behavior across similar inputs.

From a computer-technology perspective, these limitations manifest as inefficient use of computational resources and suboptimal control of machine-learned models. Content moderation servers must repeatedly evaluate user comments at scale, yet conventional architectures do not maintain structured log information linking input text, discomfort scores, prompt sentences, and generative outputs. This lack of structured feedback inhibits systematic retraining of the evaluation model, thereby preventing the system from improving its scoring accuracy and generation control over time. In addition, known systems do not provide a unified, processor-level mechanism that (i) performs text preprocessing and quantitative discomfort scoring, (ii) conditionally generates and injects a prompt sentence into a generative AI model only when necessary, and (iii) automatically records interactions for subsequent model retraining. Consequently, operators face difficulties in tuning thresholds, maintaining consistent transformation policies, and scaling the system while preserving platform quality.

Accordingly, there is a need for a computer-implemented content processing system that improves the way a processor evaluates and transforms user-generated character information. Specifically, there is a need for a server-side architecture that (1) computes a numerical discomfort score using a trained machine learning model, (2) conditionally generates a structured prompt sentence to drive a generative AI model to produce transformed character information with reduced discomfort while preserving core semantic content, and (3) logs the evaluation and generation processes in a form suitable for automated retraining and continuous improvement of the underlying models. Such a system should enhance the robustness, adaptability, and efficiency of the content moderation pipeline, thereby improving the operation of the computer system itself in processing user-generated text.

The specific processing by the specific processing unit 290 of the data processing device 12 in Example 1 is realized by the following means.

The present invention provides a server comprising a processor, a storage device, a communication interface, and a user interface, the processor being configured to receive character information from a user terminal via the communication interface, store the character information in the storage device, present the character information in an input region, perform preprocessing including string normalization and word segmentation on the stored character information, calculate, by using a trained machine learning model, a numerical score representing a discomfort level of the character information based on the preprocessed character information, compare the numerical score with a predetermined threshold value, determine whether rewriting of the character information is required when the numerical score exceeds the predetermined threshold value, generate, when the numerical score exceeds the predetermined threshold value, a prompt sentence including the character information and instruction content for reducing the discomfort level, input the prompt sentence to a generative artificial intelligence model to perform a natural language generation process and obtain transformed character information in which the discomfort level is reduced while semantic content of the character information is maintained, select presentation character information by choosing the character information itself when the numerical score is equal to or less than the predetermined threshold value and by choosing the transformed character information when the numerical score exceeds the predetermined threshold value, transmit the presentation character information to the user terminal via the communication interface, store the presentation character information as associated information in the storage device, and store, as log information, at least the numerical score, the prompt sentence, and a generated result of the natural language generation process and periodically or conditionally execute an update process to retrain the trained machine learning model based on the log information and the numerical score. This enables a technically improved content processing pipeline in which the server dynamically controls invocation of a generative AI model based on quantitative discomfort evaluation, preserves core semantic content while reducing discomfort, and continually refines the evaluation model through logged interactions, thereby enhancing the efficiency, accuracy, and adaptability of computer-implemented moderation of user-generated text.

The term “processor” refers to a hardware or virtual computation unit, such as a central processing unit or a processing core in a computing device, that executes instructions to perform operations including receiving data, performing machine learning inference, generating prompt sentences, and controlling input/output with other components of the system.

The term “storage device” refers to a non-transitory computer-readable medium, such as a semiconductor memory, magnetic storage, or optical storage, that stores character information, presentation character information, log information, trained models, and configuration data for use by the processor.

The term “communication interface” refers to a hardware and software communication module, such as a network interface controller and a communication stack, that enables data transmission and reception between the server and external devices, including user terminals, via a communication network.

The term “user interface” refers to a hardware and software configuration, including display devices and input controls, that presents information to a user and receives input from the user, such as an input region for character information.

The term “user terminal” refers to an electronic device operated by a user, such as a client computing device, that sends character information to the server and receives presentation character information via the communication network.

The term “character information” refers to text data composed of one or more characters or symbols input by a user, including, for example, comments, messages, or feedback, that is processed by the system.

The term “presentation character information” refers to character information selected by the processor for display to a user or other users, the presentation character information being either the original character information or transformed character information.

The term “preprocessing” refers to a set of operations performed on character information before evaluation by a machine learning model, including at least string normalization and word segmentation, and optionally including additional text processing such as tokenization or removal of certain symbols.

The term “string normalization” refers to a process of converting character information into a canonical or standardized representation, such as converting characters to a unified case, normalizing character encodings, or removing or converting specific control characters.

The term “word segmentation” refers to a process that divides character information into smaller linguistic units, such as words, tokens, or subword units, suitable for numerical feature extraction and input to a machine learning model.

The term “trained machine learning model” refers to a model generated by a machine learning algorithm that has been trained on training data to output a numerical score or other prediction, and that is stored and used by the processor to evaluate character information.

The term “numerical score” refers to a quantitative value, such as a real number, generated by the trained machine learning model to represent an estimated discomfort level or other evaluation metric of the character information.

The term “discomfort level” refers to a measure of how likely character information is to cause negative emotional response, offense, or discomfort to a typical user, as estimated by a trained machine learning model.

The term “predetermined threshold value” refers to a reference value stored in the system and used by the processor to compare with the numerical score in order to decide whether to perform transformation of the character information.

The term “prompt sentence” refers to a textual instruction sequence generated by the processor, including at least the character information and instruction content, and provided as input to a generative artificial intelligence model to control a natural language generation process.

The term “instruction content” refers to text within the prompt sentence that specifies a target behavior for the generative artificial intelligence model, such as reducing discomfort level while maintaining semantic content.

The term “generative artificial intelligence model” refers to a machine-learned generative model, such as a generative AI model based on a neural network, that receives a prompt sentence as input and outputs generated text including transformed character information.

The term “natural language generation process” refers to a computational process in which the generative artificial intelligence model generates output text in a human language based on a prompt sentence and optionally other input conditions.

The term “transformed character information” refers to text generated by the generative artificial intelligence model from a prompt sentence, in which the discomfort level of the original character information is reduced while at least a core part of the semantic content is maintained.

The term “semantic content” refers to the essential meaning or factual message conveyed by character information, independent of specific wording or stylistic choices.

The term “log information” refers to data stored by the system that records details of processing events, including at least character information identifiers, numerical scores, prompt sentences, and generated results of the natural language generation process.

The term “update process” refers to a computational procedure in which the trained machine learning model is retrained or fine-tuned based on accumulated log information and numerical scores, thereby modifying model parameters to improve future evaluation performance.

The term “communication network” refers to any wired or wireless network infrastructure that allows data communication between the server and user terminals, including local networks and wide-area networks.

The term “generated result” refers to the output produced by the generative artificial intelligence model in response to a prompt sentence, including but not limited to the transformed character information.

In one embodiment, a server includes a processor, a main memory, a non-transitory storage device, a communication interface, and a user interface device such as a display and input controller. The server is connected to one or more terminals operated by users via a communication network. The terminals each include at least a processor, a memory, a display, and an input device such as a physical keyboard or a touch-sensitive panel.

The server executes an operating system such as a general-purpose server operating system, and executes application software implementing a content processing service. The server stores in the storage device a set of software modules including a preprocessing module, a feature extraction module, a discomfort evaluation module, a prompt generation module, a generative AI client module, a post-processing module, a presentation selection module, a logging module, and a retraining module. The server also stores one or more trained machine learning models for discomfort evaluation and configuration data including threshold values and model version identifiers.

The terminal executes a client application such as a web browser or a native application. The terminal provides a graphical user interface that allows the user to input character information, such as comments or reviews, and to display presentation character information returned by the server. The terminal transmits character information to the server through the communication network using a network protocol such as HTTP over a secure transport protocol.

The user operates the terminal and inputs character information through the displayed input region. The terminal transmits the character information to the server as text data together with associated metadata such as a user identifier and a timestamp. The terminal subsequently receives presentation character information from the server and displays the presentation character information in a comment list or similar display area.

The server stores received character information in the storage device in association with an internal comment identifier, the user identifier, and the timestamp. In one example, the server uses a relational database management system and a table structure in which each record includes at least fields for an original_comment string, a transformed_comment string, a discomfort_score numeric value, a status flag, and model version fields.

The server performs preprocessing on the stored character information using the preprocessing module. In one implementation, the preprocessing module includes text normalization procedures that operate on a character sequence. The server converts all alphabetic characters to a unified case, unifies full-width and half-width characters, and normalizes Unicode representations so that semantically identical characters are mapped to a single internal representation. The server removes or converts control characters and certain punctuation symbols according to a rule table stored in the storage device.

The server performs word segmentation on the normalized character information. In one embodiment, the server uses a tokenization algorithm that splits the character sequence into tokens based on whitespace and punctuation, and applies a dictionary-based or statistical segmentation method for languages without explicit word boundaries. The server represents each token as an integer index by referencing a vocabulary structure stored in memory. The server thus transforms a variable-length character string into a sequence of token identifiers.

The server converts the token sequence into numerical feature vectors using the feature extraction module. In one embodiment, the server uses a term frequency-inverse document frequency (TF-IDF) representation. The server accesses a TF-IDF vectorizer configuration stored in the storage device, retrieves precomputed inverse document frequency values, and computes a sparse feature vector for the comment. In alternative embodiments, the server uses word embedding methods and obtains a sequence of dense vectors for each token, optionally aggregating them into a fixed-length representation by averaging or by passing them through a neural network.

The server evaluates a discomfort level of the character information using the discomfort evaluation module. In one embodiment, the server uses a trained neural network model composed of an embedding layer, a bidirectional recurrent layer such as a long short-term memory layer, and one or more fully connected layers with nonlinear activation functions.

The server loads model parameters from the storage device into memory and executes matrix multiplications, bias additions, and activation evaluations using a numeric computation library. The server inputs the feature vector or token embedding sequence to the neural network and obtains an output value between zero and one representing a numerical discomfort score. The server uses a loss function such as binary cross entropy during training, and updates weights by a gradient-based optimization method such as stochastic gradient descent with momentum or an adaptive learning rate method. The server may also use regularization techniques and data augmentation during training to improve robustness and generalization.

The server stores the numerical discomfort score in association with the comment record. The server then compares the numerical discomfort score with a predetermined threshold value.

The threshold value is stored in a configuration file or database table and may differ by content category or user group. When the numerical discomfort score is equal to or less than the threshold value, the server classifies the comment as acceptable without modification.

The server, when the numerical discomfort score is equal to or less than the threshold value, uses the presentation selection module to select the original character information as presentation character information. The server stores an indication that no transformation has been applied and transmits the original character information to the terminal as presentation character information. The terminal displays the original character information in the comment list without modification.

The server, when the numerical discomfort score exceeds the threshold value, generates a prompt sentence using the prompt generation module. The server constructs a text string that includes at least the original character information and instruction content for a generative AI model. The server may embed the original character information as a quoted segment within the prompt sentence, and may include explicit constraints instructing the generative AI model to reduce the discomfort level, to preserve core semantic content, and to avoid adding new factual statements.

The server, for example, generates a prompt sentence such as:
“Please rewrite the following user comment to reduce its discomfort level and offensive tone, while keeping the core message and factual content: ‘This service is terrible.’”

The server may also generate alternative prompt sentences, such as:
“The following user comment may be offensive. Rewrite it into a polite and constructive sentence with lower discomfort level, without changing the essential meaning: ‘The support team is useless and rude.’”

The server sends the prompt sentence to a generative AI model using the generative AI client module. In one embodiment, the generative AI model is a transformer-based neural network implemented as a large language model. The server transmits the prompt sentence via the communication interface to an inference server that hosts the generative AI model. The server receives an output sequence of tokens, decodes the tokens into text, and treats the resulting text as transformed character information.

The server performs post-processing on the transformed character information. The server may trim leading and trailing whitespace, normalize punctuation, and ensure that the transformed character information satisfies a maximum length requirement. The server may also apply a secondary filter that checks that prohibited terms are not present and that the transformed character information is not empty. The server then stores the transformed character information in association with the original comment in the storage device.

The server selects the transformed character information as presentation character information for comments whose numerical discomfort scores exceed the threshold value. The server transmits the transformed character information to the terminal and marks the comment record with a status indicating that transformation has been applied. The terminal displays the transformed character information to other users, while the server maintains both the original and transformed versions internally.

The server maintains detailed log information using the logging module. For each processed comment, the server stores in the storage device the original character information, the numerical discomfort score, the threshold value used, the generated prompt sentence, the transformed character information, the model version identifiers, and a timestamp for each processing stage. The log information is stored in a structured data format so that it can be queried efficiently by the retraining module.

The server executes the retraining module periodically or under specified conditions. The server retrieves a set of logged records and optionally a set of human annotations indicating whether the generated transformations were suitable. The server constructs a training dataset containing comment texts and corresponding target discomfort labels, optionally including derived labels based on user feedback or human review. The server reinitializes or fine-tunes the neural network model used for discomfort evaluation by loading the training dataset into memory and performing multiple passes of forward and backward propagation. The server computes a loss function, calculates gradients by backpropagation, and updates model weights by an optimization algorithm until convergence criteria are satisfied. The server then stores the updated model parameters as a new model version and updates the configuration so that subsequent evaluations use the improved model.

The server achieves technical effects that are not merely automation of human review. By integrating the numerical discomfort evaluation and generative AI-driven rewriting with structured logging and retraining, the server reduces the need for repeated transmission of misclassified comments to human moderators and improves the accuracy of subsequent evaluations. The server reduces computational overhead by invoking the generative AI model only for comments whose numerical discomfort score exceeds the threshold value, thereby lowering communication load and inference cost for the generative AI model. The server improves processing speed and scalability by using compact numerical feature representations and efficient neural network architectures, enabling high-throughput evaluation of comments in real time. The server further improves data management by storing links between original comments, scores, prompt sentences, and generative outputs, enabling efficient auditing and targeted retraining.

The server also implements processing rules that differ from simple human judgment. For example, the server uses a predefined numeric threshold and quantitative loss minimization during training, which are not used in manual review. The server constructs prompt sentences according to a rule-based template that encodes constraints on semantic preservation and tone reduction, which leads to consistent transformation behavior across similar inputs. The server uses specific architectural choices—such as bidirectional recurrent layers or transformer encoders—to capture long-range dependencies in text, and these architectural choices result in improved discomfort classification accuracy and more stable control over the generative AI model.

The server can be configured with multiple alternative embodiments. In one embodiment, the server replaces the recurrent neural network in the discomfort evaluation module with a convolutional neural network or a transformer encoder. In another embodiment, the server uses character-level tokenization instead of word-level tokenization to better handle rare words and spelling variations. In another embodiment, the server employs an ensemble of multiple machine learning models and combines their outputs by weighted averaging or voting to generate a more robust numerical discomfort score.

The server can adjust the predetermined threshold value adaptively based on system load, user group, or historical performance metrics. For example, the server may lower the threshold in contexts where a stricter moderation policy is required, and may raise the threshold in contexts where more direct language is acceptable. The server may also maintain multiple thresholds for different languages or content categories, with separate models and configurations for each category.

The server can use additional features beyond token-based text features. For example, the server may derive syntactic features such as part-of-speech tags, dependency relations, or sentence length; the server may also use metadata features such as time of posting or user behavior statistics. The server concatenates such features with text embeddings to create an extended feature vector for the discomfort evaluation module. This combination allows the neural network to learn patterns that involve both language and context, leading to higher accuracy and fewer false positives or false negatives.

The terminal can be a wide variety of devices, such as a smartphone, a tablet computer, a laptop computer, or a desktop computer. The terminal is not limited to a specific platform.

The terminal simply performs display and input operations and relies on the server for heavy computation, thereby enabling centralized control of model versions and thresholds. The user does not need to understand or control the internal processing; however, the user benefits from smoother interactions on the platform, as the server presents comments in a less offensive but semantically faithful manner.

In summary, the server uses a combination of trained machine learning models, structured prompt sentences for a generative AI model, and a closed-loop retraining mechanism to improve the technical performance of computer-based content processing. This configuration leads to improved discomfort evaluation accuracy, controlled and consistent text transformation, reduced communication and computation load on the generative AI model, and improved management and reuse of logged data, thereby enhancing the operation of the overall computer system.

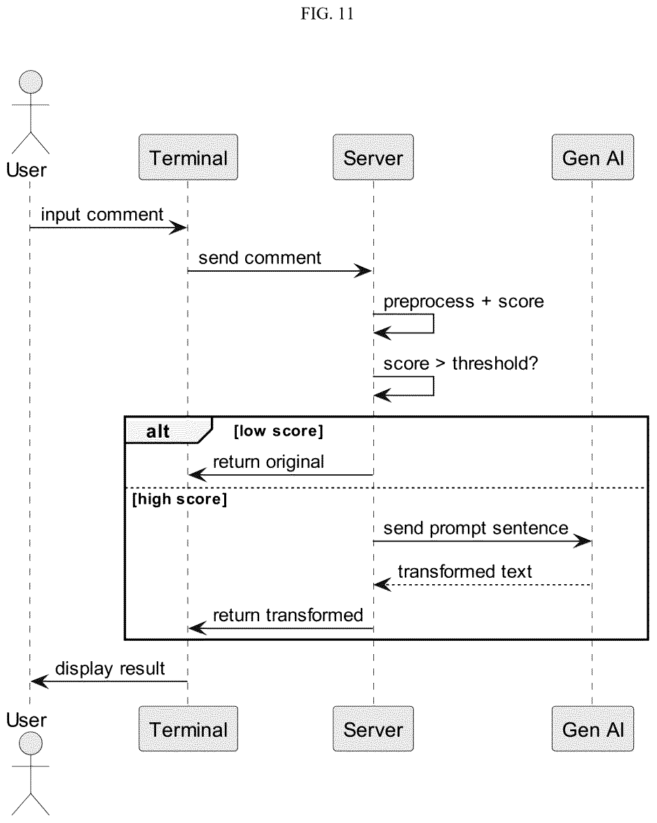

The following describes the processing flow using FIG. 11.

### Step 1:

The user operates the terminal and opens an application or web page of the online platform. The terminal displays an input area and a submit control on the display. The user enters character information, for example “This service is terrible.”, using a hardware keyboard or a touch-screen keyboard. The terminal takes the entered text as input, attaches metadata such as a user identifier and a timestamp, and constructs a request message. The terminal outputs the request message, including the character information as a text field, and transmits it to the server via a communication network using a protocol such as HTTPS.

### Step 2:

The server receives the request message via the communication interface. The server takes the request, including the raw character information and metadata, as input. The server parses the request headers and body, extracts the character information string, and validates that the string length and encoding satisfy predefined constraints stored in configuration data. The server outputs a validated text string and associated metadata. The server then writes a new record into a storage device, for example a relational database, storing the original character information, the user identifier, and an initial status flag, and assigns a unique comment identifier as part of the output of this step.

### Step 3:

The server retrieves the stored character information from the storage device using the comment identifier as input. The server executes a preprocessing module that takes the original text string as input and performs string normalization operations. The server converts characters to a unified case, normalizes character encodings, and removes or replaces specified control characters according to a rule table. The server then performs word segmentation by applying a tokenization algorithm that splits the text into tokens based on whitespace, punctuation, and language-specific rules. The server outputs a sequence of normalized tokens and an internal representation of the original comment suitable for numerical feature generation.

### Step 4:

The server invokes a feature extraction module and uses the token sequence as input. The server maps each token to an integer index using a vocabulary table stored in memory, and computes numerical feature vectors. In one implementation, the server calculates a TF-IDF vector by counting token frequencies and multiplying by stored inverse document frequency values. In another implementation, the server looks up pre-trained embedding vectors for each token and aggregates them, for example by averaging or by passing them through a neural network layer. The server outputs a fixed-length numerical feature vector or a sequence of embedding vectors representing the semantic content of the original character information.

### Step 5:

The server inputs the numerical feature representation into a trained machine learning model for discomfort evaluation. The server loads model parameters for a neural network (for example, an embedding layer, a bidirectional recurrent layer, and fully connected layers) from the storage device into memory before inference. The server performs numerical computations including matrix multiplications, bias additions, and activation function evaluations (for example, rectified linear units and sigmoid functions) using a numerical computation library on a processor or an accelerator. The server computes a numerical discomfort score in the range from 0 to 1 as output. The server writes the discomfort score into the corresponding database record as part of the output of this step.

### Step 6:

The server takes the numerical discomfort score and a predetermined threshold value as input. The server compares the discomfort score with the threshold value stored in configuration data. The server executes a decision operation: when the score is less than or equal to the threshold, the server determines that rewriting is not required; when the score exceeds the threshold, the server determines that rewriting is required. The server outputs a decision flag indicating whether transformation is required, and updates the status field of the comment record accordingly.

### Step 7:

The server, when the decision flag indicates that transformation is not required, uses the original character information and the discomfort score as input. The server selects the original character information as presentation character information without modification.
The server may perform minimal formatting operations, such as trimming surrounding whitespace. The server stores the selection result in the storage device and outputs the original character information as the presentation character information to be sent back to the terminal.

### Step 8:

The server, when the decision flag indicates that transformation is required, uses the original character information and internal policy parameters as input to a prompt generation module.
The server constructs a prompt sentence by inserting the original comment into a template string that includes instructions for a generative AI model. The server, for example, generates the following prompt sentence as output:
“Please rewrite the following user comment to reduce its discomfort level and offensive tone, while keeping the core message and factual content: ‘This service is terrible.’”

In another example, the server generates:
“The following user comment may be offensive. Rewrite it into a polite and constructive sentence with lower discomfort level, without changing the essential meaning: ‘The support team is useless and rude.’”
The server outputs the completed prompt sentence as a text string.

### Step 9:

The server submits the prompt sentence as input to a generative AI model via a generative AI client module. The server formats an inference request according to an external API specification, embeds the prompt sentence in the request body, and transmits the request to an inference endpoint over the communication interface. The generative AI model, implemented as a transformer-based neural network on a remote computation system, processes the prompt and returns generated text. The server receives the response message, parses the response to extract the generated text segment, and outputs this generated text as transformed character information.

### Step 10:

The server takes the transformed character information as input to a post-processing module. The server applies string operations to remove leading and trailing whitespace, normalize punctuation, and ensure that the transformed character information does not exceed a configured maximum length. The server may optionally perform a secondary check for disallowed terms using a lightweight filter. The server then writes the transformed character information into the database record associated with the original comment, and sets the status flag to indicate that transformation has been performed. The server outputs the cleaned transformed character information as presentation character information.

### Step 11:

The server takes the selected presentation character information (either original or transformed), along with the comment identifier and discomfort score, as input to a response generation module. The server constructs a response message that includes fields for the comment identifier, the presentation character information, and optionally the discomfort score or processing status. The server outputs the response message and transmits it to the terminal via the communication interface using a network protocol.

### Step 12:

The terminal receives the response message from the server. The terminal takes the response message as input, parses it, and extracts the presentation character information and associated metadata. The terminal updates the user interface by inserting the presentation character information into a comment list or feed displayed on the screen. The terminal may render the comment with additional visual indicators that represent time of posting or other attributes. The terminal outputs an updated display to the user, showing the version of the comment that the server has selected and, if transformed, the softened wording.

### Step 13:

The server simultaneously records log information using the logging module. The server takes, as input, at least the original character information, the transformed character information (if present), the numerical discomfort score, the threshold value, the generated prompt sentence, the model version identifiers, and time stamps for key processing events.
The server inserts a log record into a log table or writes a structured entry to a log storage system. The server outputs a persistent log entry that associates each input comment with its evaluation and generation history, thereby forming a data source for later analysis and retraining.

### Step 14:

The server, at a later time, uses stored log information as input to the retraining module. The server selects a subset of log entries based on criteria such as time range, score distribution, or human feedback annotations. The server extracts text and label pairs, where labels may indicate discomfort levels or suitability of transformations. The server constructs a training dataset in memory, and executes a training loop for the discomfort evaluation model. The server computes a loss function such as binary cross-entropy on batches of examples, calculates gradients via backpropagation, and updates model weights using an optimization algorithm. The server outputs updated model parameters and stores them as a new version in the storage device, improving the accuracy and stability of future discomfort evaluations.

### Step 15:

The server may adjust configuration parameters, including the predetermined threshold value, based on statistical analysis of the log information. The server uses aggregated statistics, such as the distribution of discomfort scores and the frequency of transformations, as input. The server evaluates trade-offs between transformation frequency and user satisfaction metrics, and computes a revised threshold value or model selection rule. The server writes updated configuration values to the storage device and outputs these updated values to be used in subsequent evaluation and decision steps, thereby adapting the system behavior to operational requirements and improving overall technical performance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content moderation techniques for online communication environments primarily rely on rule-based filtering or single-stage machine learning classifiers that merely block, hide, or flag user-generated text containing offensive or uncomfortable expressions. Such approaches suffer from several technical limitations. First, systems that simply reject or delete input text provide no meaningful feedback path to the user and therefore do not support iterative, computer-assisted improvement of the text. As a result, network traffic must repeatedly traverse the client-server boundary for trial-and-error submissions, increasing processing load and latency on networked computing resources.

Second, conventional systems typically evaluate discomfort levels using monolithic classification logic, without structured preprocessing of the input text into numerical feature representations suitable for multi-stage inference and transformation. This limits the accuracy and robustness of discomfort detection for varied linguistic patterns and contexts, and can lead to unnecessary false positives or negatives in automated moderation pipelines. Third, existing systems generally do not integrate rule-based linguistic transformations with generative models in a closed-loop process; as a consequence, generated alternative expressions are not programmatically constrained or re-evaluated, which can cause unstable output quality, inconsistent discomfort reduction, and repeated manual intervention by human moderators.

Furthermore, client-side interfaces in conventional systems rarely support real-time or near real-time feedback during text entry. In many architectures, the entire comment is transmitted only after the user finishes typing and explicitly submits the input, at which point the system either accepts or rejects the comment. This lack of incremental interaction increases round-trip latency and reduces the efficiency of the underlying computing infrastructure, because the system cannot guide users to less uncomfortable expressions during the composition phase. As a result, server resources are frequently consumed by processing fully offensive or unusable inputs, and the user experience is degraded due to delayed feedback and multiple submission attempts.

Accordingly, there is a need for an improved computer-implemented system that (i) performs structured preprocessing of character information to generate numerical representations suited for discomfort evaluation, (ii) combines rule-based linguistic transformations and generative artificial intelligence models via prompt sentences in a multi-stage rewriting pipeline, (iii) programmatically re-evaluates generated candidate text to confirm that a discomfort level lies within a predetermined range before publication, and (iv) supports real-time interaction with terminal devices by sequentially evaluating partial input and presenting candidate alternative expressions. Such a system should reduce computational waste, improve the stability and accuracy of automated discomfort reduction, decrease network round trips caused by failed submissions, and enhance overall performance and responsiveness of the underlying computing infrastructure.

The specific processing by the specific processing unit 290 of the data processing device 12 in Application Example 1 is realized by the following means.

The present invention provides a server comprising a processor configured to receive user information from a terminal device as character information, preprocess the character information to convert the character information into structured information in units of words or sentences, generate a numerical vector based on the structured information, input the numerical vector into a machine learning model to obtain a discomfort score, compare the discomfort score with a predetermined threshold, generate first candidate information for character information determined to have a high discomfort level by performing replacement processing using dictionary information and rule information, generate a prompt sentence including the first candidate information and the character information, operate a generative artificial intelligence model using the prompt sentence as input to generate second candidate information in which the discomfort level is reduced, re-evaluate the discomfort level with respect to the second candidate information to confirm that the discomfort level is within a predetermined range and thereby determine the second candidate information as converted information, and transmit at least one of the converted information and the character information to the terminal device for presentation, accept an approval input or a correction input from a user, and, in response to the approval input, store the converted information or the character information as publication information and make the publication information retrievable from another terminal device. This enables an improvement in computer technology by implementing a multi-stage, machine-executed discomfort evaluation and rewriting pipeline that uses numerical feature representations and generative models under programmatic control, thereby reducing unnecessary network round trips, lowering processing overhead for rejected inputs, stabilizing the quality of rewritten text through automated re-evaluation, and providing real-time interactive guidance to terminal devices that enhances the efficiency and responsiveness of the underlying data processing system.

The term “user information” refers to data representing content provided by a human operator, including at least character information such as text input, comments, messages, or other linguistic expressions entered via a terminal device.

The term “terminal device” refers to an electronic apparatus operated by a user, including at least a computing device having an input unit, a display unit, a communication unit, and a memory, such as a mobile device, a stationary device, or a browser-executing device, which transmits user information to and receives information from a server.

The term “character information” refers to information expressed as a sequence of symbols that can be represented as text data, including letters, numerals, punctuation marks, and other language characters encoded in a character encoding scheme.

The term “structured information” refers to information obtained by processing character information into a machine-readable form that explicitly represents linguistic structure, including at least segmentation into words or sentences, and optionally including tokenization, part-of-speech tags, and other linguistic attributes.

The term “numerical vector” refers to a data structure including at least one ordered collection of numerical values that encode features of structured information, suitable for input into a computational model such as a machine learning model.

The term “machine learning model” refers to a computational model implemented by a processor and configured to perform inference on numerical vectors based on parameters obtained through training, including at least models that output a discomfort score or classification result for given input.

The term “discomfort level” refers to a quantitative or qualitative measure indicating a degree to which character information is likely to be perceived as offensive, aggressive, or otherwise uncomfortable, as estimated by a machine learning model or equivalent evaluation algorithm.

The term “evaluation result” refers to information generated by a processor based on processing of a numerical vector with a machine learning model, including at least a discomfort score, a classification label, or other data used to decide whether character information requires conversion.

The term “discomfort score” refers to a numerical value output by a machine learning model that represents at least a probability or intensity measure of discomfort associated with given character information.

The term “predetermined threshold” refers to a reference value stored in a memory and used by a processor to compare with a discomfort score, thereby determining at least whether character information is to be converted or left unchanged.

The term “dictionary information” refers to data stored in a memory and representing a collection of lexical items and associated attributes, including at least mappings between words and their synonyms, alternative expressions, or semantic categories used for replacement processing.

The term “rule information” refers to data representing a plurality of conditions and associated operations, including at least linguistic rules, replacement conditions, and transformation patterns used by a processor to perform rule-based modification of character information.

The term “replacement processing” refers to processing in which a processor systematically substitutes one or more portions of character information with alternative expressions based on dictionary information and rule information, thereby generating modified text.

The term “first candidate information” refers to character information obtained by a processor as a first-stage transformation result from original character information, generated at least by replacement processing using dictionary information and rule information, before processing by a generative artificial intelligence model.

The term “prompt sentence” refers to character information constructed by a processor and provided as input to a generative artificial intelligence model, the character information including at least instructions, constraints, and one or more pieces of content such as original character information and first candidate information.

The term “generative artificial intelligence model” refers to a computational model configured to generate character information based on an input prompt sentence, including at least models that use probabilistic or neural methods to produce new text conditioned on the prompt.

The term “second candidate information” refers to character information generated by a generative artificial intelligence model based on a prompt sentence, the character information being intended to have a reduced discomfort level relative to corresponding original character information.

The term “converted information” refers to character information determined by a processor as a final transformation result after evaluating a discomfort level of second candidate information and confirming that the discomfort level satisfies a predetermined condition, the character information being suitable for presentation or publication.

The term “re-evaluation of the discomfort level” refers to processing in which a processor applies a discomfort evaluation procedure to second candidate information or other transformed character information, using at least a machine learning model, to verify that the resulting discomfort level falls within an allowable range.

The term “publication information” refers to character information stored in a memory in association with identification data and made available for retrieval and display to one or more terminal devices, including at least converted information or original character information approved for public presentation.

The term “approval input” refers to an operation performed by a user via a terminal device to indicate consent for publication of particular character information, including at least an operation that selects acceptance of converted information or original character information.

The term “correction input” refers to an operation performed by a user via a terminal device to modify or revise character information presented by a server, including at least manual editing, addition, or deletion of parts of the text.

The term “another terminal device” refers to a terminal device different from a terminal device that transmitted original user information, which is capable of requesting and receiving publication information from a server.

The term “partial character information” refers to character information representing a portion of a complete user input that is being composed, the portion being transmitted from a terminal device to a server before completion or final submission of the entire text.

The term “real time” refers to an operation mode in which a server processes partial character information and returns evaluation results or candidate expressions to a terminal device with latency low enough that a user can perceive the response substantially concurrently with, or shortly after, input actions during text entry.

In one embodiment, a server implements the claimed system using one or more general-purpose processors, a main memory, a non-volatile storage unit, and a network interface. The server executes an operating system and an application program implemented in a programming language. The server communicates with one or more terminal devices via a communication network. Each terminal device includes at least a processor, a memory, a display unit, an input unit, and a communication interface, and executes a client-side application such as a native application or a browser-based application. A user operates the terminal device to input character information and to view converted information.

The server stores, in a storage unit, a program that causes the processor of the server to function as a plurality of logical modules including at least a reception module, a preprocessing module, a feature vector generation module, a discomfort evaluation module, a rule-based conversion module, a prompt sentence generation module, a generative AI interaction module, a re-evaluation module, a presentation module, and a storage module. Each module is implemented by executable instructions and data structures, and the modules cooperate via shared memory, message queues, or function calls.

The server receives user information from the terminal device as character information. The server acquires, for example, a comment entered by the user in a text input field of the terminal device. The server stores the received character information in a text buffer in the memory. The server may also store metadata such as a user identifier, a content identifier, a timestamp, and a terminal device type in association with the character information in a structured record.

The server preprocesses the stored character information. The server normalizes Unicode code points, converts full-width characters to half-width characters where applicable, unifies line break codes, and normalizes whitespace by collapsing multiple space characters. The server further applies tokenization to split the character information into tokens corresponding to words or subwords. The server may apply sentence boundary detection to identify sentence units. The server can implement tokenization and sentence segmentation using a natural language processing library or custom code, and stores the resulting tokens and sentence boundaries in an internal data structure, such as an array of tokens with associated indices and part-of-speech tags.

The server generates a numerical vector from the structured information. The server maps each token to an integer index using a vocabulary table stored in the storage unit. The server then converts the integer indices to dense embedding vectors stored in an embedding matrix.

The embedding matrix is a two-dimensional array of floating-point values, in which one dimension corresponds to vocabulary indices and another dimension corresponds to embedding dimensions. The server concatenates or aggregates the embedding vectors to form at least one numerical vector representing the entire character information. The numerical vector may have a fixed length, and the server may pad or truncate tokens to conform to this length. This numerical vector constitutes an input feature for the discomfort evaluation model, and enables efficient use of vectorized arithmetic instructions and hardware acceleration.

The server evaluates a discomfort level of the character information using a machine learning model. In one example, the server implements a neural network classifier including an embedding layer, one or more recurrent layers such as a bidirectional long short-term memory layer, one or more fully connected layers, and an output layer having at least one node for producing a discomfort score. The server stores model parameters such as weight matrices, bias vectors, and recurrent cell parameters in the storage unit and loads them into memory at initialization. The server feeds the numerical vector into the neural network, and the processor computes matrix multiplications, activation functions, and recurrent operations to produce an output value between 0 and 1. The server interprets this output as a discomfort score indicating a probability or degree of discomfort. The server may apply a sigmoid function or a softmax function at the output layer. The server may further generate an auxiliary classification label, such as “low discomfort” or “high discomfort,” based on comparison of the discomfort score with a predetermined threshold.

The server obtains the predetermined threshold from a configuration file or a database. The server stores the threshold as a floating-point value in memory. The server compares the discomfort score with the threshold using arithmetic comparison instructions. When the discomfort score is greater than or equal to the threshold, the server determines that the character information has a high discomfort level. When the discomfort score is less than the threshold, the server determines that the character information has a low discomfort level.

This comparison decouples the evaluation scale from the decision boundary, enabling dynamic tuning of sensitivity while reusing the same model.

The server, in response to determination that the character information has a high discomfort level, performs rule-based conversion to generate first candidate information. The server uses dictionary information stored in the storage unit. The dictionary information includes mappings from offensive or strongly negative expressions to milder expressions or phrases that introduce subjectivity or hedging. For example, the dictionary information may map “boring” to “not very engaging for me” and “stupid” to “difficult for me to understand.” The server also uses rule information representing transformation rules such as syntactic templates, insertion of first-person pronouns, and softening of imperative forms. For instance, the rule information may specify replacement of “You must” with “You might want to consider,” or insertion of a phrase such as “In my opinion” at the beginning of a sentence.

The server applies these rules to the token sequence, replaces target tokens with substitute tokens, and rearranges local token order when required by grammar rules. The server then reconstructs the token sequence into character information, thereby generating first candidate information. This rule-based conversion is explicitly encoded and deterministic, and leverages structured data and predefined rules that are not simply mirroring human editing.

The server generates a prompt sentence to guide a generative AI model using both the original character information and the first candidate information. The server constructs the prompt sentence as character information combining a role description, processing instructions, and content examples. In one example, the server generates a prompt sentence as follows:
“You are a content moderation assistant for an online communication platform.

A user comment is given. First, evaluate how uncomfortable or offensive the comment might be.

Then rewrite the comment into a softer and more polite expression that keeps the original meaning
but avoids offensive or aggressive language. Use natural, conversational language.

Original User Comment:
‘This video is boring and the creator is stupid.’

### First-Pass Softened Version:

‘For me, this video is not very engaging and I find it hard to understand the creator's approach.’

Return only the final rewritten comment text, without any explanations.”

The server stores the prompt sentence in a string buffer, and may adjust certain portions such as the original comment and the first candidate information. The explicit construction of such a prompt sentence defines a constrained generation context and reduces variance in the generative AI output.

The server interacts with a generative AI model to generate second candidate information.

The generative AI model may be implemented on the same server or on another computing device reachable via a communication network. In one embodiment, the generative AI model is a transformer-based neural network including a plurality of self-attention layers, feed-forward layers, and layer normalization layers. The model is trained on a large corpus of text using an autoregressive or sequence-to-sequence learning objective. The server encodes the prompt sentence into token IDs using a tokenizer compatible with the generative AI model and sends these token IDs to the model. The model outputs a sequence of tokens representing the rewritten comment. The server decodes the sequence of tokens into character information, thereby obtaining second candidate information.

The server designedly uses the generative AI model as a constrained rewriting component rather than as an unbounded generation engine. By combining rule-based conversion and assisted generative rewriting, the server reduces the search space for the generative AI model. The presence of first candidate information and explicit instructions in the prompt sentence biases the generative AI output toward reduced-discomfort expressions that remain close to the original semantics. This architecture contributes to improved stability and computational efficiency, because the generative AI model does not need to reconstruct an entirely new text from unconstrained instructions, and fewer iterations are required to obtain acceptable outputs.

The server re-evaluates a discomfort level of the second candidate information by applying the same discomfort evaluation model used for the original character information. The server converts the second candidate information to a numerical vector using the same preprocessing and feature generation modules. The server inputs the numerical vector into the neural network classifier, and obtains a second discomfort score. The server verifies that the second discomfort score is below the predetermined threshold or within another acceptable range. This closed-loop evaluation constitutes a technical control mechanism that filters outputs of the generative AI model and ensures that only character information meeting a quantifiable criterion is accepted as converted information. When the second discomfort score remains high, the server may apply modified rule-based processing, adjust the prompt sentence to instruct stronger softening, or fall back to a highly neutral template expression.

The server transmits converted information or unconverted character information to the terminal device for presentation. The server constructs a response message that includes at least the text to be displayed and, optionally, information indicating whether conversion has been applied and the associated discomfort score. The server sends the response message using a communication protocol. The terminal device receives the response, decodes the data, and displays the converted information or the original character information in a user interface region such as a preview panel or confirmation dialog. The user then selects an approval input or a correction input. The terminal device sends the user's selection and, in the case of correction, the corrected text, back to the server.

The server, in response to an approval input, stores the converted information or the original character information as publication information in a database. The server creates a record including fields such as a text field, a user identifier, a content identifier, a timestamp, a discomfort score, and a flag indicating whether conversion was applied. The server indexes the record to support efficient retrieval by other terminal devices. The server thus enables consistent and controlled publication of moderated content.

The server, in another embodiment, receives partial character information from the terminal device during text entry. The terminal device, in this embodiment, transmits character sequences while the user is typing, for example when a pause exceeding a predetermined time occurs or when the number of characters increases by a predetermined amount. The server evaluates a discomfort level for the partial character information using the same preprocessing and discomfort evaluation model as described above. The server generates candidate uncomfortable expressions and alternative expressions by applying targeted rule-based detection and replacement to the partial character information. The server may also generate a short prompt sentence for the generative AI model, such as:
“You are a writing assistant.
The following text is being typed by a user.
Suggest a softer alternative for any part that may sound offensive or too aggressive, while keeping the user's basic intention.
User text: ‘This idea is stupid.’
Return only one improved sentence.”

The server obtains a suggested alternative from the generative AI model and merges it with the partial input context. The server returns these candidates to the terminal device in real time. The terminal device underlines potentially uncomfortable expressions or displays alternative phrases in a selection list next to the text input field. The user can select an alternative expression, and the terminal device replaces the corresponding portion of the text. This real-time guidance reduces the number of fully uncomfortable submissions and decreases the computational load associated with full comment rejection and resubmission cycles.

The server, by implementing the above-described multi-stage processing, improves computer technology in several specific ways. First, the server reduces communication overhead and end-to-end latency by performing early, fine-grained discomfort evaluation on partial input and by reusing structured numerical vectors for both initial evaluation and re-evaluation, rather than performing separate, redundant processing. Second, the server increases evaluation accuracy by combining explicit rule-based identification with a trained neural network classifier that uses distributed word representations and contextual sequence modeling, thereby reducing false positives and false negatives compared with purely rule-based or purely generative approaches. Third, the server enhances stability and efficiency of generative text rewriting by constraining the generative AI model with a prompt sentence derived from first candidate information, which narrows the model's search space and yields higher-quality outputs with fewer iterations. Fourth, the server improves data management by maintaining structured records that store both original and converted information together with corresponding discomfort scores and thresholds, enabling subsequent retraining, auditing, and analysis with lower processing cost.

The server trains the machine learning model used for discomfort evaluation using supervised learning. The server (or an associated training subsystem) collects a training dataset consisting of text samples annotated with discomfort labels or scores. The server converts these text samples into numerical vectors using the same tokenization and embedding scheme used at inference time. The server defines a loss function such as binary cross-entropy between predicted scores and ground truth labels. During training, the server updates the neural network parameters using an optimization algorithm such as stochastic gradient descent or a variant with adaptive learning rates. The server applies techniques such as mini-batching, gradient clipping, and regularization to stabilize training. The server may augment the training data by applying synonym replacement, noise injection, or paraphrasing to improve robustness. Once training is complete, the server stores the model parameters and deploys the model for inference within the described system. This explicit learning process yields a model that consistently maps feature vectors to discomfort scores with improved accuracy over heuristic methods.

The server trains the generative AI model using sequence modeling objectives. In one embodiment, the server pretrains a transformer network on large volumes of general text with a language modeling objective. The server can further fine-tune the model on domain-specific data that includes pairs of original and softened expressions. The server defines a loss function such as cross-entropy between predicted next tokens and reference tokens. The server updates model parameters by backpropagation through time and uses techniques such as attention masking, positional encoding, and layer normalization. By fine-tuning with examples of offensive and softened pairs, the model internalizes patterns of discomfort reduction that are not explicitly encoded in rule-based logic, enabling it to produce nuanced and context-appropriate rewrites. The server then uses this model under the control of prompt sentences, as described above.

The server, by combining these concrete algorithmic components, does more than merely automate a human editorial task. The server exploits specific data structures (token arrays, embedding matrices, numerical vectors), specific neural network architectures (recurrent or transformer models), and specific modular flows (preprocessing, rule-based first pass, constrained generative second pass, and numerical re-evaluation) to optimize utilization of processor cycles, memory bandwidth, and network resources. The causal relationship between these technical features and the resulting effects is clear: the structured representations and neural processing yield more precise discomfort scores; the constrained generative pipeline reduces the need for repeated generation; the real-time partial evaluation reduces unnecessary transmission of fully uncomfortable texts; and the integrated logging of scores and outcomes enables incremental model improvement. Accordingly, the system achieves improvements in processing speed, evaluation accuracy, resource utilization, and overall responsiveness of the underlying computing infrastructure.

In another embodiment, the server can use a different architecture for the discomfort evaluation model, such as a convolutional neural network or a transformer encoder model.

The server may vary the size of embedding vectors, the number of layers, and the activation functions to adapt to available hardware resources. The server may also employ quantization or pruning techniques to reduce model size and inference latency. Furthermore, the server can implement the generative AI model locally or via a remote service, and may adjust the maximum generation length, sampling temperature, or decoding algorithm (for example, greedy decoding, beam search, or nucleus sampling) in accordance with target latency and quality requirements. These variations all fall within the scope of the claimed system as long as the server uses the described multi-stage procedure of numerical evaluation, rule-based conversion, prompt-based generation, and numerical re-evaluation to control publication of character information.

In another embodiment, the server can integrate additional metadata, such as user history or content category, into the numerical vector fed to the discomfort evaluation model. The server may concatenate or otherwise combine text-based features with user-related or context-related features, and the neural network may include additional branches to process such information. This integration allows the server to adapt the discomfort evaluation to different communities or content types while maintaining the same technical pipeline.

Likewise, the server can maintain multiple thresholds for different categories and apply them dynamically. These variations further illustrate how the claimed system operates as a configurable, technically grounded platform for discomfort-controlled text conversion, rather than as a static rule set or abstract business method.

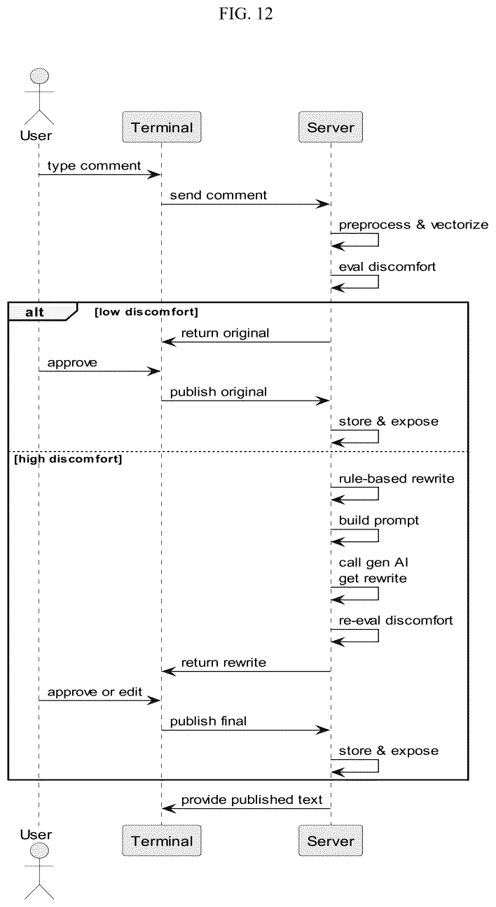

The following describes the processing flow using FIG. 12.

### Step 1:

The user operates the terminal to input character information.
The user opens an application on the terminal and types a comment, such as “This video is boring and the creator is stupid,” into a text input field. The terminal captures each keystroke and constructs a text string in a memory buffer. The terminal uses a local input method editor to handle character composition and updates the displayed text in real time.
Input: user key events and existing text buffer.
Output: updated text buffer containing the full comment string.

### Step 2:

The terminal prepares a request message and sends the character information to the server.
The terminal converts the text buffer into a character string encoded in a character encoding scheme and attaches metadata such as a user identifier and a content identifier. The terminal constructs a structured message (e.g., including fields for user ID and comment text) in its memory. The terminal then transmits this message to the server over a network using a communication protocol.
Input: comment text string and local metadata.
Output: network request payload transmitted from the terminal to the server.

### Step 3:

The server receives the request and stores the character information.
The server's communication interface accepts the incoming request and passes the payload to an application process. The server decodes the character string, validates the format, and writes the text and metadata into a temporary data structure in memory. The server may also append a timestamp and generate an internal request identifier.
Input: network request payload containing the character string and metadata.
Output: in-memory record including normalized character information and associated metadata.

### Step 4:

The server preprocesses the character information into structured information.
The server reads the character string from the in-memory record and applies normalization operations such as whitespace normalization, case normalization, and standardization of punctuation. The server then performs tokenization to split the string into tokens corresponding to words or subwords, and optionally detects sentence boundaries. The server organizes tokens into an ordered list and may attach part-of-speech tags.
Input: normalized character string.
Output: structured information represented as an ordered token list and, optionally, sentence and tag annotations.

### Step 5:

The server generates a numerical vector from the structured information.
The server maps each token to a numerical index using a vocabulary mapping table stored in memory. The server then retrieves or computes an embedding vector for each index from an embedding matrix. The server aggregates these embedding vectors into a fixed-length representation by performing operations such as padding, truncation, and concatenation, and optionally applies pooling functions. This processing converts discrete tokens into a dense numerical vector suitable for input to a machine learning model.
Input: ordered token list and vocabulary mapping.
Output: numerical vector (or tensor) representing the comment.

### Step 6:

The server evaluates a discomfort score using a machine learning model.
The server supplies the numerical vector to a neural network classifier instantiated in memory. The server executes a sequence of matrix multiplications, nonlinear activation functions, and, if applicable, recurrent or attention operations to propagate the numerical vector through the layers of the network. The final layer produces a scalar value between 0 and 1 that the server interprets as a discomfort score.
Input: numerical vector representing the comment.
Output: discomfort score indicating a degree of discomfort.

### Step 7:

The server compares the discomfort score with a predetermined threshold and classifies the comment.
The server retrieves a threshold value from configuration storage and compares the discomfort score with this threshold using a numerical comparison operation. If the discomfort score is greater than or equal to the threshold, the server sets a high-discomfort flag; otherwise, the server sets a low-discomfort flag. The server updates the in-memory record to include the score and the flag.
Input: discomfort score and threshold value.
Output: classification result (high discomfort or low discomfort) stored with the record.

### Step 8:

The server branches processing for low-discomfort character information.
If the classification result indicates low discomfort, the server prepares a response message that includes the original character information and the discomfort score. The server does not modify the text. The server encodes the text and score into the response format and sends the response to the terminal over the network.
Input: low-discomfort flag and original character information.
Output: response message containing the unmodified comment and associated score.

### Step 9:

The terminal presents the low-discomfort comment and waits for user approval.
The terminal receives the response, parses the content, and displays the comment in a confirmation area of the user interface. The terminal highlights that no conversion was applied. The user reviews the comment and performs an approval input, such as pressing a “Publish” button. The terminal captures this interaction and prepares a publication request containing the approved text.
Input: response message with unmodified comment.
Output: publication request from the terminal containing the approved comment.

### Step 10:

The server performs rule-based conversion for high-discomfort character information.
If the classification result indicates high discomfort, the server activates a rule-based conversion module. The server scans the token list and compares each token against a dictionary of terms associated with high discomfort. The server identifies tokens such as strong insults or absolute judgments. For each identified token, the server selects a milder alternative from dictionary entries and applies transformation rules that adjust surrounding words, such as inserting “for me” or “in my opinion” before statements or changing imperative forms into suggestions. The server then reconstructs the modified token sequence into a new character string, which becomes first candidate information.
Input: high-discomfort flag, original token list, dictionary information, and rule information.
Output: first candidate information representing a rule-based softened version of the comment.

### Step 11:

The server constructs a prompt sentence for a generative AI model.
The server reads the original character information and the first candidate information from memory and inserts them into a template of instructions. The server creates a continuous text instruction that describes the role of the generative AI model, the required transformation, and the example content. The server concatenates the instruction text, the original comment, and the first candidate into one character string. For example, the server may construct the following prompt sentence:
“You are a content moderation assistant for an online communication platform.
A user comment is given. First, evaluate how uncomfortable or offensive the comment might be.
Then rewrite the comment into a softer and more polite expression that keeps the original meaning but avoids offensive or aggressive language. Use natural, conversational language.
Original user vomment:
‘This video is boring and the creator is stupid.’
First-pass softened version:
‘For me, this video is not very engaging and I find it hard to understand the creator's approach.’
Return only the final rewritten comment text, without any explanations.”
The server stores this prompt sentence as a character string.
Input: original comment string, first candidate information, and prompt template.
Output: constructed prompt sentence to be used as input to the generative AI model.

### Step 12:

The server provides the prompt sentence to a generative AI model and obtains second candidate information.
The server encodes the prompt sentence into a sequence of tokens compatible with the generative AI model's tokenizer. The server sends the encoded sequence to the model and initiates inference. The generative AI model processes the sequence through multiple attention and feed-forward layers and outputs a sequence of tokens that represent a rewritten version of the user comment. The server decodes this token sequence back into a character string, which becomes second candidate information.
Input: prompt sentence as a character string.
Output: second candidate information as a rewritten character string.

### Step 13:

The server re-evaluates the discomfort level of the second candidate information.
The server subjects the second candidate information to the same preprocessing pipeline used for the original comment. The server tokenizes the rewritten text, maps tokens to indices, and generates a numerical vector. The server then inputs this numerical vector into the discomfort evaluation model. The model produces a second discomfort score, and the server compares this score with the threshold. The server records whether the score is now below the threshold.
Input: second candidate information string.
Output: second discomfort score and updated classification (acceptable or not).

### Step 14:

The server determines converted information based on the re-evaluation result.
If the second discomfort score is below the threshold, the server accepts the second candidate information as converted information and marks it as suitable for publication. If the second discomfort score remains above the threshold, the server may apply additional rule-based transformations or construct an alternative prompt sentence instructing stronger softening, then request another generation from the generative AI model. The server repeats re-evaluation until converted information meeting the criterion is obtained, or falls back to a conservative template expression.
Input: second discomfort score, threshold, and second candidate information.
Output: final converted information that satisfies the discomfort criteria.

### Step 15:

The server sends the converted information and the original comment to the terminal for confirmation.
The server builds a response message containing at least the original character information, the converted information, and one or more associated scores or flags. The server encodes these fields into a format and transmits the message to the terminal through the communication interface.
Input: original comment string, converted information string, and evaluation metadata.
Output: response message delivered to the terminal.

### Step 16:

The terminal presents the converted information to the user and receives an approval or correction input.
The terminal receives the response message, extracts the original and converted texts, and displays both in the user interface. The terminal may show the converted information in a primary view and the original text in a secondary view. The user reviews the converted text and performs an approval input by selecting an “Accept” control, or performs a correction input by editing the converted text in an editable field. The terminal captures the final text decided by the user and constructs a publication request containing this text and a flag indicating approval.
Input: response message with original and converted texts.
Output: publication request including the final, user-approved text.

### Step 17:

The server stores the approved text as publication information.
The server receives the publication request and extracts the final text, user identifier, and related metadata. The server creates a new record in a persistent storage system and stores the final text as publication information, together with a reference to the original comment, the discomfort scores, and a conversion flag. The server updates indexes to allow efficient retrieval of this record for future access by other terminals.
Input: publication request with user-approved text and metadata.
Output: stored publication information record in persistent storage.

### Step 18:

The server responds to retrieval requests from other terminals with publication information.
When another terminal issues a retrieval request for comments associated with a particular content identifier, the server queries the storage system for records marked as publication information. The server compiles these records into a response message containing the final, already-processed texts and related display data. The server sends the response back to the requesting terminal.
Input: retrieval request specifying a content identifier.
Output: response message containing one or more published comments.

### Step 19:

The terminal displays publication information to other users.
The terminal receives the list of published comments and parses the contained text fields and metadata. The terminal renders each comment within a display region such as a comment list, and may show only the final, converted text without exposing the original text. The user can scroll and read these comments.
Input: response message with published comments.
Output: rendered user interface showing the published comments to the user.

### Step 20:

The terminal optionally sends partial character information for real-time evaluation during text entry.
While the user is typing a new comment, the terminal periodically extracts the current content of the text buffer and forms partial character information. The terminal sends this partial text, along with a session identifier, to the server using a lightweight request.
Input: current partial text buffer.
Output: real-time evaluation request containing partial character information.

### Step 21:

The server evaluates the partial character information and generates alternative expression candidates.
The server receives the partial text and applies a shortened preprocessing and evaluation pipeline to compute a provisional discomfort score. The server identifies specific tokens that contribute most to the score by analyzing token-level contributions or matching against a dictionary of uncomfortable expressions. For each identified token, the server applies rule-based replacements and may construct a brief prompt sentence requesting a softer alternative from the generative AI model. The server aggregates suggested alternatives and returns them within a response message.
Input: partial character information, dictionary information, rule information, and evaluation model.
Output: response message containing highlighted uncomfortable expressions and alternative expression candidates.

### Step 22:

The terminal presents real-time suggestions and updates the text based on user selection.
The terminal receives the suggestions, maps them to positions in the text input field, and visually highlights the corresponding tokens. The terminal displays one or more alternative expression candidates in a selectable list adjacent to the highlighted text. The user can tap an alternative, and the terminal replaces the highlighted portion of the text buffer with the selected candidate. The text displayed in the input field updates accordingly, and subsequent partial submissions from the terminal to the server contain the revised content.
Input: response message with suggestions and the current text buffer.
Output: updated text buffer reflecting user-selected alternatives and an improved input experience.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In online communication environments, such as comment feeds, message boards, and social networking services, user-generated text frequently contains expressions that are perceived as unpleasant, offensive, or overly aggressive. Conventional content moderation techniques rely heavily on simple keyword filters or rule-based systems executed by general-purpose processors. These techniques often misclassify benign comments that include certain words in non-offensive contexts, while failing to detect more subtle forms of unpleasantness. As a result, the precision and recall of unpleasantness detection remain unsatisfactory.

Furthermore, in systems where unacceptable comments are merely blocked or deleted, user experience is degraded by missing context in conversations, and users receive little guidance on how to express criticism in a more constructive manner. Some platforms employ manual moderation, which is costly, slow, and difficult to scale with increasing traffic. Other platforms attempt to rewrite content using generic text generation without a precise link to a quantified evaluation of unpleasantness, leading to unpredictable behavior and lack of control over when and how rewriting is triggered.

From the standpoint of computer technology, existing systems do not adequately integrate: (i) a trained statistical learning model that converts raw character information into feature values and produces a numerical unpleasantness level, (ii) a deterministic decision mechanism that compares this level with a threshold, and (iii) a conditional invocation of an external generative information processing apparatus through a structured prompt sentence that embeds the original character information. Without such integration, server-side processing pipelines are not optimized for efficient, repeatable, and auditable transformation of user-generated text. They cannot reliably ensure that computational resources for generative processing are applied only when needed, nor can they systematically record the association between original text, unpleasantness level, threshold, and transformed text in a machine-usable form.

Accordingly, there is a need for a computer-implemented technique that improves the functioning of a server by: automatically transforming user-generated character information only when a statistically-evaluated unpleasantness level meets a defined condition; orchestrating the interaction between a local evaluation model and an external generative information processing apparatus via a structured prompt sentence; and storing evaluation results and transformation attributes in a manner that allows consistent downstream processing. Such a technique should reduce the likelihood that unpleasant content is presented to users, while preserving useful information and improving the efficiency, controllability, and transparency of text moderation performed by computing resources.

The specific processing by the specific processing unit 290 of the data processing device 12 in Example 2 is realized by the following means.

The present invention provides a server comprising a processor configured to receive character information from a user terminal, convert the character information into feature values and execute a trained statistical learning model to calculate an unpleasantness level of the character information as a numerical value, compare the calculated unpleasantness level with a predetermined threshold to determine whether the character information is a conversion target, when it is determined that the character information is the conversion target, generate a prompt sentence including the character information, transmit the prompt sentence to an external generative information processing apparatus, and obtain response information including converted character information with a reduced unpleasantness level from the external generative information processing apparatus, store in a storage device the calculated unpleasantness level, the threshold, the converted character information, and attribute information indicating whether conversion has been performed in association with one another, and generate output information including either the character information or the converted character information according to a result of the determination and transmit the output information to the user terminal via a communication path. This enables an improvement in computer technology in that the server executes a coordinated pipeline in which a machine-learned evaluation model and a generative information processing apparatus are combined under explicit threshold-based control, thereby selectively invoking generative processing only when necessary, reducing computational overhead, systematically recording evaluation and transformation metadata for subsequent processing, and reliably providing moderated text output that lowers user exposure to unpleasant content while maintaining the continuity and usefulness of communicated information.

The term “system” refers to an arrangement of one or more computing devices, communication interfaces, and storage resources that cooperatively perform the operations described in the claims.

The term “server” refers to a computing device or a group of computing devices that provide processing, communication, and storage functions for handling character information received from user terminals.

The term “processor” refers to one or more hardware processing units, such as a central processing unit or a graphics processing unit, configured to execute instructions that implement the functions described in the claims.

The term “user terminal” refers to an information processing device operated by a user, such as a personal computer, a smartphone, or a tablet, that transmits character information to the server and receives output information from the server.

The term “character information” refers to digital data representing a sequence of characters, symbols, or text input by a user and processed by the server.

The term “feature values” refers to numerical or structured representations derived from character information, suitable for input into a statistical learning model.

The term “classification model” refers to a machine-learned function that receives feature values as input and outputs a value or label indicating a classification result, such as an unpleasantness level.

The term “statistical learning model” refers to a model generated by a machine learning algorithm using training data, including past character information and associated labels, to infer patterns used for prediction or evaluation.

The term “unpleasantness level” refers to a numerical value or quantification that represents an estimated degree of unpleasantness of character information as determined by the statistical learning model.

The term “predetermined threshold” refers to a reference value against which the unpleasantness level is compared to decide whether the character information should be converted.

The term “conversion target” refers to character information that has been determined, based on comparison of the unpleasantness level with the predetermined threshold, to be subject to conversion.

The term “prompt sentence” refers to instruction text generated by the processor, including the character information, which is provided as an input to an external generative information processing apparatus to obtain converted character information.

The term “external generative information processing apparatus” refers to a computing system, distinct from the server, that executes a generative AI model or similar generative processing to produce new or modified character information in response to a prompt sentence.

The term “response information” refers to data returned from the external generative information processing apparatus, including converted character information obtained through generative processing.

The term “converted character information” refers to character information that has been modified from original character information, using generative processing, so that its unpleasantness level is reduced relative to the original.

The term “storage device” refers to a memory or data storage resource, such as a non-volatile memory, a magnetic disk, or a solid-state drive, in which information processed by the server is recorded.

The term “attribute information” refers to metadata associated with character information, including at least an indication of whether conversion has been performed and optionally additional information about evaluation or processing.

The term “output information” refers to data generated by the processor for delivery to the user terminal, including either original character information or converted character information.

The term “communication path” refers to a logical or physical channel through which data is transmitted between the server and the user terminal, including networks such as wired networks, wireless networks, or the Internet.

In one embodiment, a server provides a network-based text moderation system that evaluates and conditionally transforms character information posted by a user through a terminal. The server cooperates with the terminal and a user to reduce unpleasant content in an electronic communication environment while improving computational efficiency and data management within the server.

The server includes at least one processor, a main memory, a non-volatile storage device, and a network interface. The processor is, for example, a general-purpose central processing unit or a combination of a central processing unit and an accelerator. The memory stores program instructions that implement the evaluation and conversion functions described herein. The storage device stores a database, trained model parameters, configuration values, and logs.

The network interface performs bidirectional communication with terminals and with an external generative information processing apparatus via a packet-based network.

The terminal is, for example, a personal computer, a smartphone, or a tablet device. The terminal executes a web browser or a native application that displays an input field and a comment feed to the user. The terminal transmits user-entered character information to the server in a structured format and receives output information from the server for display.

The user operates the terminal to enter character information in the form of natural language text. The user typically types a comment into a graphical user interface of the terminal and submits the comment by activating a control element. The terminal encapsulates the character information and metadata such as a user identifier, a posting time, and a context identifier and transmits this data to the server.

The server stores the received character information in a data structure suitable for later retrieval and processing. The server, for example, records each comment as a row in a relational database table with fields that include an identifier, an original_text field, an unpleasantness_score field, a threshold_value field, a transformed_text field, and a conversion_flag field. The server uses this structured data to support subsequent decision-making and to maintain an auditable history of moderation operations.

The server converts the character information into feature values that are suitable as input for a statistical learning model. The server, for example, applies a tokenization process that splits the character information into tokens, applies normalization such as lowercasing in languages where this is appropriate, and removes or maps certain control symbols. The server then constructs a sparse vector representation using a term-frequency-inverse-document-frequency scheme. The server maintains a vocabulary index in memory or in storage and uses this index as a mapping between tokens and vector dimensions. The server thereby transforms the character information into a numerical feature vector that can be efficiently processed by machine learning algorithms.

The server uses a statistical learning model that has been trained in advance on past character information and associated unpleasantness labels. In one embodiment, the server employs a linear classifier, such as a logistic regression classifier, that operates on the feature vectors. The server stores a weight vector and a bias value in the storage device. During evaluation, the server computes an inner product between the feature vector and the stored weight vector and adds the bias to obtain a scalar score. The server then applies a logistic function to the scalar score to derive an unpleasantness probability value as the unpleasantness level. In another embodiment, the server uses a multilayer neural network that includes an input layer corresponding to the feature dimensions, one or more hidden layers with non-linear activation functions, and an output layer that produces the unpleasantness level. The server stores numeric parameters (weights and biases) of the neural network in memory and computes layer outputs by performing matrix multiplications and non-linear transformations, such as rectified linear unit functions or hyperbolic tangent functions, on the feature vector.

The server trains the statistical learning model using supervised learning prior to deployment.

The server obtains a training dataset that includes a plurality of character information samples and associated unpleasantness labels, such as binary labels or multi-level labels. The server initializes the model parameters and iteratively updates the parameters using a gradient-based optimization method, such as stochastic gradient descent or a variant thereof. During training, the server computes a loss function, such as cross-entropy loss between predicted unpleasantness levels and ground-truth labels, and updates the parameters by propagating gradients of the loss with respect to the parameters. The server may perform regularization by adding a penalty term, such as an L2 norm of the parameter vector, to the loss function. Through this learning process, the server obtains a model that captures statistical patterns relating character features to unpleasantness.

The server sets and stores a predetermined threshold value for the unpleasantness level in a configuration table. The server may select the threshold based on validation experiments to balance false positive and false negative rates. The server compares the unpleasantness level computed by the model with the threshold. When the unpleasantness level exceeds the threshold, the server identifies the corresponding character information as a conversion target. When the unpleasantness level does not exceed the threshold, the server identifies the character information as not requiring conversion.

The server generates a prompt sentence when the character information is determined to be the conversion target. The server uses a template that includes explicit instructions for transforming the character information. The server inserts the original character information into a placeholder region of the template. For example, in one embodiment the server generates the following prompt sentence in English:
“The following user comment may sound unpleasant. Please rewrite it into a less unpleasant, polite, and constructive expression while preserving the original intent as much as possible. Comment: ‘This feature is absolutely useless!’”

In another embodiment, the server generates a prompt sentence in another language, such as:
“The following user comment may be perceived as offensive. While preserving the original intent as much as possible, please rewrite it in a polite and constructive expression with a lower degree of offensiveness. Comment: ‘This feature is completely unusable!’”

The server thereby encodes both the transformation objective and the original character information into the prompt sentence. By using a structured template and fixed instruction phrases, the server ensures predictable and controllable behavior of the generative AI model that is executed on the external generative information processing apparatus.

The server transmits the prompt sentence to the external generative information processing apparatus via the network interface. The external generative information processing apparatus executes a generative AI model, such as a neural language model that uses a transformer architecture. In such an architecture, the model comprises multiple layers of self-attention sublayers and feed-forward sublayers. The external apparatus converts tokens in the prompt sentence into vector embeddings, applies positional encodings, and repeatedly processes these vectors through attention mechanisms with multiple attention heads. The external apparatus uses learned parameters to compute attention scores and linear projections, and then generates a sequence of output tokens that form converted character information. The external apparatus returns the converted character information to the server as part of response information.

The server receives the response information and extracts the converted character information. The server may apply post-processing operations, such as trimming whitespace and removing extraneous prefixes, to normalize the converted character information. The server then stores the converted character information in the transformed_text field of the database row corresponding to the original character information. The server sets the conversion_flag field to indicate that conversion has occurred. The server may also store the unpleasantness level and threshold value with the character information to provide a traceable record of the evaluation and conversion process.

The server generates output information based on the determination result. When conversion is not required, the server includes the original character information in the output information. When conversion is required and has been completed, the server includes the converted character information in the output information. The server transmits the output information through the network interface to the terminal. In some cases, the server may attach metadata that indicates whether the text was converted, but the visual representation on the terminal may be identical to that of a normal comment from the viewpoint of other users.

The terminal receives the output information and updates its display accordingly. The terminal, for example, inserts the received text into a comment feed area by updating application state or browser document elements. The user and other viewers can then read the moderated content. The user may not need to perform any additional actions, because the server-side conversion process is transparent to the user interaction at the terminal.

The server improves computer technology by using the unpleasantness level and the threshold to control when the external generative information processing apparatus is invoked. Because the server evaluates and filters character information using the local statistical learning model before sending a prompt sentence, the server significantly reduces the number of calls to the generative AI model. This selective invocation reduces communication overhead and processing load on both the server and the external apparatus, which improves response time and throughput in high-traffic environments. The server also reduces unnecessary generative processing that would otherwise be applied to benign comments.

The server further improves the accuracy and consistency of moderation by coupling a trained evaluation model with a generative AI model via a structured prompt sentence. The server uses feature-based evaluation rather than simple keyword matching, which allows more precise detection of subtle unpleasantness patterns. The server can capture context and expression style learned from the training data and apply these patterns to new comments. The deterministic threshold-based logic ensures that moderation behavior is repeatable and auditable, which is not the case when generative rewriting is applied indiscriminately.

The server improves data management by systematically storing the original character information, the unpleasantness level, the threshold, and the converted character information in a unified database schema. Because the server associates these values with each comment, the server can later perform offline analysis, such as recalibrating thresholds, retraining models, or auditing moderation outcomes. This structure enables continuous technical improvement of the model performance, such as reducing classification error, and makes it easier to diagnose misclassifications and adjust model parameters.

The server employs non-conventional processing steps that differ from mere automation of human moderation. Human reviewers do not naturally operate on explicit feature vectors, perform inner products with trained weight vectors, or compute logistic functions to quantify unpleasantness. The server, in contrast, applies a structured algorithmic pipeline: converting text into numerical feature values, computing a mathematically defined unpleasantness level with a trained model, and enforcing a precise decision rule that gates the invocation of generative processing. This pipeline uses objective quantification and machine-learned mapping that are not present in human judgment, thereby enabling consistent and scalable moderation behavior.

The server can implement alternative embodiments to further improve technical performance. In one variation, the server compresses and caches feature vectors for frequently evaluated text segments to avoid recomputation, thereby reducing processing time for duplicate or near-duplicate comments. In another variation, the server adjusts the threshold dynamically based on system load or user group attributes stored in metadata, thereby balancing precision and computational resources. In yet another variation, the server executes multiple evaluation models in parallel, each specialized for a specific language or domain, and selects the appropriate model based on detected language attributes of the character information.

The server may also implement alternative generative processing strategies. For example, the server can restrict the length of the prompt sentence and the maximum number of generated tokens to control latency and network traffic. The server can randomize certain prompt parameters, such as a temperature value within a predefined range, to reduce determinism while still constraining outputs to polite forms. The server can further filter the converted character information using an additional lightweight classifier that checks for remaining undesirable expressions before transmission to the terminal.

Through these configurations, the server, the terminal, and the user cooperate to realize a text moderation system in which character information is objectively evaluated and selectively transformed based on well-defined numerical criteria and generative AI processing. The interaction between the statistical learning model, the prompt sentence generation logic, and the generative AI model produces technical effects that include improved moderation accuracy, reduced processing load, and enhanced data management. These effects arise from specific data structures, algorithmic flows, and module configurations executed by computing hardware, and thus constitute an improvement in computer technology rather than an abstract automation of a human task.

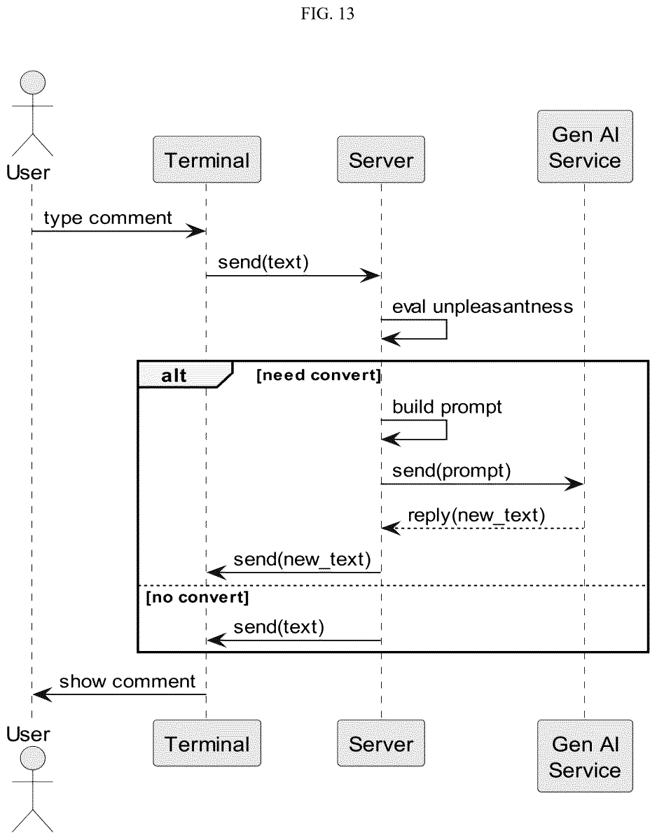

The following describes the processing flow using FIG. 13.

### Step 1:

The user inputs character information into an input field displayed on the terminal.
The terminal receives, as input, keystroke events or touch input from the user and aggregates them into a text string, together with associated metadata such as a user identifier and a context identifier.
The terminal outputs a structured data object, for example including fields “user_id”, “context_id”, and “text”, and packages this data into a request message to be sent to the server.

### Step 2:

The terminal transmits the structured data object to the server over a network.
The terminal uses the structured data object from Step 1 as input and serializes the object into a format such as JSON, then sends it in a network request message via a communication protocol.
The terminal outputs a network packet stream that contains the serialized character information and metadata addressed to the server's network interface.

### Step 3:

The server receives the network request from the terminal.
The server takes the incoming network packet stream as input and reconstructs the request message using a network stack implementation and an application protocol handler.
The server outputs a parsed request object that includes the original text string, the user identifier, and the context identifier, which is made available to an application layer module.

### Step 4:

The server stores the received character information in a persistent storage device.
The server uses the parsed request object from Step 3 as input and inserts a new record into a comment table in a database, assigning a unique identifier and initializing fields for unpleasantness level, threshold value, transformed text, and a conversion flag.
The server outputs a database record handle or identifier that uniquely represents the stored comment and associates this identifier with the processing context for subsequent steps.

### Step 5:

The server preprocesses the character information to generate a normalized text representation.
The server takes the original text from the database record as input and applies text normalization operations, such as converting to a canonical encoding, normalizing whitespace, optionally converting case, and removing control characters.
The server outputs a cleaned text string that is more suitable for feature extraction and consistent evaluation by the statistical learning model.

### Step 6:

The server converts the normalized text into numerical feature values.
The server uses the cleaned text string from Step 5 as input and performs tokenization, mapping tokens to indices in a stored vocabulary, and computing feature values such as term-frequency-inverse-document-frequency scores or embedding vectors.
The server outputs a numerical feature vector or matrix, which is typically represented as a sparse or dense array suitable for input to the statistical learning model.

### Step 7:

The server evaluates the unpleasantness level of the character information using a statistical learning model.
The server takes the numerical feature vector from Step 6 as input and applies a trained model, such as a logistic regression classifier or a neural network, by computing inner products, adding biases, and applying activation functions to produce a scalar unpleasantness score or probability.
The server outputs an unpleasantness level value, for example a real number between 0 and 1, and stores this value in the unpleasantness_score field of the corresponding database record.

### Step 8:

The server compares the unpleasantness level with a predetermined threshold to decide whether the character information is a conversion target.
The server uses the unpleasantness level from Step 7 and a stored threshold value from a configuration table as inputs and executes a comparison operation to determine if the level is greater than or equal to the threshold.
The server outputs a boolean decision result indicating either “conversion required” or “conversion not required”, and may also update an internal processing state associated with the comment.

### Step 9:

The server identifies the character information as a conversion target or as non-target based on the decision result.
The server uses the boolean decision from Step 8 as input and updates the conversion_flag field in the database record to indicate the status, while preserving the original text and unpleasantness level.
The server outputs an updated database record state and a control flow signal: if conversion is required, further steps for prompt sentence generation are initiated; otherwise, the processing path bypasses generative conversion.

### Step 10:

The server generates a prompt sentence when conversion is required.
The server takes, as input, the original text string and the decision result indicating that conversion is required, and inserts the original text into a pre-defined instruction template that specifies transformation goals such as reducing unpleasantness while preserving intent.
The server outputs a complete prompt sentence, for example:
“The following user comment may sound unpleasant. Please rewrite it into a less unpleasant, polite, and constructive expression while preserving the original intent as much as possible. Comment: ‘This feature is absolutely useless!’”, or, in another language:
“The following user comment may be perceived as offensive. While preserving the original intent as much as possible, please rewrite it in a polite and constructive expression with a lower degree of offensiveness. Comment: ‘This feature is completely unusable!’”.

### Step 11:

The server transmits the prompt sentence to an external generative information processing apparatus that executes a generative AI model.
The server uses the generated prompt sentence from Step 10 as input and encapsulates it into a request message that includes model parameters such as a target model name, maximum output length, and randomness control values.
The server outputs a network request directed to the external apparatus, which, when sent over the network interface, causes the external apparatus to start generative processing using the prompt sentence.

### Step 12:

The server receives response information including converted character information from the external generative information processing apparatus.
The server takes the incoming network response containing the result of generative AI processing as input and parses the response to extract the converted text portion that represents the rewritten, less unpleasant version of the original character information.
The server outputs a converted text string and associates it with the corresponding database record for the original comment.

### Step 13:

The server post-processes the converted character information and updates the database record.
The server uses the converted text string from Step 12 as input and applies formatting normalization, such as trimming whitespace, removing control characters, and ensuring encoding consistency with system requirements.
The server outputs a normalized converted text string and stores this string in the transformed_text field of the database record, sets the conversion_flag to indicate that conversion has been performed, and may also update a timestamp indicating when conversion occurred.

### Step 14:

The server selects the final text for presentation to the terminal based on the decision result.
The server takes, as input, the boolean decision from Step 8 and, when available, the converted text from Step 13, and chooses either the original text or the converted text as the final display content.
The server outputs a final text value, together with metadata such as the comment identifier, unpleasantness level, and conversion_flag, packaged into an output information structure.

### Step 15:

The server transmits the output information to the terminal for display.
The server uses the output information structure from Step 14 as input and serializes it into a response message suitable for the terminal, attaching appropriate header information for routing and interpretation.
The server outputs a network response that carries the final text and associated metadata back to the terminal over the communication path.

### Step 16:

The terminal receives the output information and updates a user interface component.
The terminal takes the network response from the server as input and parses the content to extract the final text and related metadata.
The terminal outputs an updated visual representation, for example inserting the final text into a comment list on the screen, optionally storing status flags in local memory to indicate that the text has been moderated.

### Step 17:

The user views the displayed final text and continues interaction if desired.
The user receives, as input, the visual output generated by the terminal and perceives either the original or the converted character information, depending on the server's processing.
The user outputs, in terms of system interaction, further operations such as reading, scrolling, replying, or entering additional comments, thereby initiating new instances of the processing flow described in the preceding steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content moderation systems that attempt to reduce unpleasantness or offensiveness of user-generated text are typically implemented as rule-based filters or as simple classification engines that block, hide, or crudely mask text. Such systems suffer from several technical limitations.

First, known systems generally apply a fixed mapping from detected “bad” words to “acceptable” words without taking into account a numerical unpleasantness level of the entire text or a dynamically computed emotional state of the user. As a result, the same transformation logic is applied uniformly, regardless of context or user state, which can lead to excessive censorship, loss of semantic nuance, and degraded user experience.

Second, where machine learning models are used, these models are often deployed as black-box classifiers that output a label (for example, offensive or non-offensive) but are not tightly integrated into a coordinated pipeline that (i) numerically scores unpleasantness, (ii) combines that score with an estimated user emotion intensity, and (iii) conditionally triggers a generative rewriting process only when technically justified. This lack of integration causes unnecessary calls to computationally expensive generative models, increasing latency and resource consumption on servers and networks.

Third, when generative AI models are used to rewrite content, existing solutions typically send only the raw text to the model, without providing an explicit, structured prompt that encodes machine-interpretable parameters such as the unpleasantness score and the user emotional state. This makes the behavior of the generative AI model less controllable and less reproducible, and can lead to outputs that still contain high unpleasantness or that diverge too far from the user's intended meaning. As a result, the system must often perform additional post-processing or multiple regeneration cycles, further increasing processing time and computational load.

Fourth, many systems either automatically replace the user's text without user involvement or merely block the text, forcing the user to re-enter a new message. Such approaches provide no integrated mechanism for presenting multiple AI-generated alternatives together with the original text, obtaining explicit user selection or editing input, and then using that input as the final publication data. This creates friction for the user and prevents efficient human-in-the-loop moderation.

Fifth, existing architectures frequently treat emotion analysis and text transformation as separate subsystems without a unified control flow. They do not implement a processor-level control mechanism that, based on numeric thresholds for unpleasantness and emotion intensity, determines both whether to trigger rewriting and which variant (original or transformed) to present. This leads to sub-optimal decisions and inconsistent behavior, and prevents effective real-time adaptation to user state.

Accordingly, there is a need for an improved computer-implemented system and method that technically enhances the way user text is processed on a server. In particular, there is a need for a processor-controlled pipeline that (i) numerically evaluates unpleasantness of character information, (ii) estimates a user emotional state, (iii) conditionally generates and uses prompt sentences that include these machine-computed attributes as input to a generative AI model, and (iv) presents one or more transformed alternatives together with the original text for user selection. Such a system should reduce unnecessary calls to generative models, improve controllability and quality of generated text, and enhance overall efficiency and reliability of computer-based comment moderation.

The specific processing by the specific processing unit 290 of the data processing device 12 in Application Example 2 is realized by the following means.

The present invention provides a server comprising a processor configured to receive character information from a user via an input/output interface, preprocess the character information into analysis data, input the analysis data into a machine learning model to calculate a numerical unpleasantness value, estimate an emotional state of the user by using an emotion analysis function, determine, based on the unpleasantness value and the emotional state, whether the character information is to be a target for transformation, generate, when the character information is determined to be the target for transformation, a prompt sentence including at least the character information and the unpleasantness value and input the prompt sentence into a generative AI model to generate transformed character information having a lower unpleasantness level, retain, when the character information is determined not to be the target for transformation, the character information without transformation, present at least one of the transformed character information and the untransformed character information to the user, accept an operation from the user regarding adoption or editing of character information presented to the user, and, based on a result of the operation, store selected character information as publication data and output the publication data to an external destination. This enables a technically integrated moderation pipeline in which the server selectively invokes a generative AI model only when numerical unpleasantness and emotion thresholds justify rewriting, controls the behavior of the generative AI model through structured prompt sentences that embed machine-computed scores, reduces computational overhead by avoiding unnecessary generation, improves the reliability and consistency of transformed text, and supports efficient human-in-the-loop selection and publication of moderated content.

The term “processor” refers to a hardware or virtual computing element, such as a central processing unit or processing core, capable of executing instructions to perform the operations described herein.

The term “character information” refers to digital text data composed of one or more characters, including letters, digits, symbols, or punctuation, that is input, processed, transformed, or output by the system.

The term “input/output interface” refers to a hardware or software interface that enables exchange of data between a user and the system, including but not limited to graphical user interfaces, web interfaces, application programming interfaces, keyboards, touchscreens, and communication ports.

The term “preprocess” refers to performing one or more operations on raw character information to produce analysis data, such operations including but not limited to tokenization, normalization, encoding, and feature extraction.

The term “analysis data” refers to a representation of character information that has been preprocessed into a form suitable for input to a computational model, such as a machine learning model.

The term “machine learning model” refers to a computational model trained on data to perform a task such as classification or regression, which, when provided with analysis data, outputs a numerical or categorical result including an unpleasantness value.

The term “unpleasantness value” refers to a numerical score, probability, or metric indicating a degree of unpleasantness, offensiveness, or negative impact associated with character information, as computed by the machine learning model.

The term “emotion analysis function” refers to a computational function, module, or model that estimates an emotional state of a user based on input data such as past user behavior, text, or sensor information.

The term “emotional state” refers to an estimated psychological or affective condition of a user, such as calmness, anger, or stress, which may be represented as a label, a numerical score, or a combination thereof.

The term “target for transformation” refers to a classification indicating that character information satisfies one or more conditions, including threshold conditions for the unpleasantness value and the emotional state, such that the system is configured to rewrite the character information.

The term “prompt sentence” refers to a text sequence, formatted as a natural language instruction or query, that is generated by the system and input to a generative AI model to control how the generative AI model processes and rewrites character information.

The term “generative AI model” refers to a computational model for natural language generation that, when provided with a prompt sentence, generates new text such as transformed character information based on learned language patterns.

The term “transformed character information” refers to character information generated by the generative AI model or by related natural language processing operations, which is intended to convey substantially the same meaning as original character information while having a lower unpleasantness value.

The term “untransformed character information” refers to original character information that has not been rewritten or modified by the generative AI model or other transformation processes.

The term “present” refers to causing information to be visually or audibly output to a user through an input/output interface, such as by rendering text on a display or outputting speech through an audio device.

The term “operation from the user” refers to an explicit input provided by the user, such as selection, approval, rejection, or editing, made via an input/output interface with respect to character information presented by the system.

The term “publication data” refers to character information that has been finalized for external use, including text that is stored in association with content or user identifiers and is made available to one or more external destinations such as online services, databases, or communication channels.

The term “external destination” refers to a system, service, data store, or device outside the processor that receives publication data, including but not limited to network services, content platforms, or client devices.

The term “threshold” refers to a predetermined numerical value or condition used to compare against the unpleasantness value or the emotional state intensity in order to decide whether to perform a transformation or to present original character information.

The term “plurality of types of transformed character information” refers to two or more distinct alternative versions of transformed character information generated by the generative AI model in response to one or more prompt sentences.

The term “store” refers to writing or maintaining data, such as character information or publication data, in a memory or storage medium accessible to the processor.

The term “output” refers to transmitting or otherwise providing data from the system to an external destination, including sending data over a network or writing data to an external storage or service.

In one embodiment, a server implements the claimed system as a network-connected computing apparatus comprising at least one processor, a main memory, a non-volatile storage device, and a network interface. The server runs an operating system such as a general-purpose server operating system and executes an application program written in a high-level language such as Python or another interpreted or compiled language. The server executes a web framework, for example a framework equivalent to Flask, Django, or FastAPI, to expose application programming interfaces that receive and return character information over a network.

A terminal operates as a client device such as a smartphone, tablet, personal computer, or head-mounted display. The terminal executes a web browser or a native application that presents a graphical user interface including an input field for character information, one or more buttons for sending and confirming information, and a display region for showing transformed character information. The terminal is connected to the server via a communication network using communication protocols such as HTTP or WebSocket.

A user interacts with the terminal by entering character information such as comments or messages into the input field. The user may type, for example, “This video is boring,” “This product is totally useless!,” or “This movie is the worst!” into the interface. The terminal transmits the entered character information as text data together with optional metadata such as a user identifier, language indicator, and timestamp to the server through a request message.

The server stores and processes the character information using structured data formats. The server represents each piece of character information as a record in a relational or document-oriented data store. The record may comprise fields such as a comment identifier, raw text string, token sequence, unpleasantness value, emotional state vector, prompt sentence string, and flags indicating transformation status and publication status. By maintaining these fields, the server can manage the flow of data through the processing pipeline and can avoid repeated or unnecessary computation.

The server preprocesses the character information by executing a natural language processing pipeline implemented using a library such as NLTK, spaCy, or an equivalent natural language toolkit. The server converts the raw text into a token sequence, applies normalization (lowercasing, punctuation handling, and whitespace normalization), and encodes tokens as integer identifiers according to a vocabulary that is shared with a machine learning model. The server may generate additional features such as token type indicators, sentence boundaries, and character-level n-gram statistics. The server stores the generated analysis data in memory as tensors or multi-dimensional arrays suitable for input to machine learning models.

The server evaluates an unpleasantness value of the character information using a machine learning model deployed within the server process. In one embodiment, the server uses a neural network model implemented with a machine learning framework such as TensorFlow, PyTorch, or an equivalent deep learning library. The model may adopt an architecture based on a bidirectional recurrent neural network, a convolutional neural network, a Transformer encoder, or a hybrid of these architectures. For example, the server may employ a multi-layer Transformer encoder with self-attention, where token embeddings are processed through multiple attention heads and feed-forward layers, and a pooled representation of the sequence is input to a fully connected layer that outputs a scalar unpleasantness value through a sigmoid or softmax activation.

The server trains the unpleasantness model in advance using a training dataset composed of past character information paired with human-annotated unpleasantness labels or scores. During training, the server computes a loss function such as binary cross-entropy or mean squared error between predicted unpleasantness values and ground-truth labels. The server updates model parameters using a gradient-based optimization algorithm such as stochastic gradient descent, Adam, or another optimizer. The server may perform data augmentation by randomly masking tokens, shuffling clauses, or adding synthetic noise to improve robustness. By performing this training process, the server obtains a parameterized model that can infer an unpleasantness value from new character information with improved accuracy compared with simple keyword-based filters.

The server also estimates an emotional state of the user using an emotion analysis function implemented as a separate computational module. The server can implement the emotion analysis function as a neural network model similar to the unpleasantness model, trained on data where user text or interaction history is labeled with emotional states such as “calm,” “angry,” “sad,” or “stressed.” Alternatively, the server can call an external sentiment or emotion analysis application programming interface. In either case, the server obtains an emotional state representation, such as a vector of emotion scores or a discrete label together with an intensity measure. The server stores this information in association with the comment record.

The server determines whether the character information is to be a target for transformation by applying control logic that compares the unpleasantness value and the emotional state intensity against configured thresholds. For example, the server may compare the unpleasantness value against a first threshold and compare an anger intensity score against a second threshold. The server classifies the character information as a transformation target only when the unpleasantness value is equal to or greater than the first threshold and the anger intensity is equal to or greater than the second threshold. Conversely, the server can classify the character information as safe to present in original form when the unpleasantness value is below the first threshold and the emotional state is below a calmness-related threshold. This decision logic is implemented as program code executed on the processor and is not based on a simple keyword list; instead it uses numerical outputs of machine learning models, which allows more fine-grained control and reduces false positives.

The server constructs a prompt sentence for a generative AI model when the character information is determined to be a target for transformation. The server generates the prompt sentence by concatenating a fixed instruction template with the original character information and, optionally, the computed unpleasantness value and the emotional state. For example, the server may generate a prompt sentence such as:
“Rewrite the following user comment into a wording with a lower degree of unpleasantness while preserving its meaning: ‘This video is boring.’”
or
“User comment: ‘This product is totally useless!’ Please generate an alternative expression that is less offensive but keeps the user's opinion.”
or
“User comment: ‘This movie is the worst!’ Please rewrite this sentence into a less offensive expression while preserving the user's opinion.”
or
“Input a user comment, evaluate its degree of unpleasantness, and, if necessary, rewrite it into a milder wording. Comment: ‘This product doesn't work at all!’”

By explicitly embedding numeric or categorical attributes such as the unpleasantness value into the prompt sentence, the server constrains the behavior of the generative AI model in a non-trivial manner, improving reproducibility and controllability of outputs compared with sending only the raw text.

The server applies a generative AI model implementing a natural language generation architecture to transform the character information. In one embodiment, the server uses a generative AI model based on a Transformer decoder with self-attention and cross-attention to prompt tokens, trained on large-scale text data for language modeling tasks. The server may deploy the generative AI model locally using a library such as a general-purpose Transformer framework, or may access it as a remote service via an API. The server inputs the constructed prompt sentence into the generative AI model together with generation parameters such as maximum output length, temperature, and nucleus sampling probability. The generative AI model outputs one or more candidate transformed character information strings.

The server may generate a plurality of types of transformed character information by repeating the generation process with different random seeds or sampling parameters, or by using a decoding strategy that returns multiple beams in a beam search. The server stores these multiple candidate strings in association with the comment record. By generating multiple candidates, the server allows the user to choose a preferred expression, thereby combining automatic generation with human judgment.

The server performs post-processing on the generated candidate strings using natural language processing techniques. The server may use a library equivalent to spaCy or NLTK to perform tokenization, part-of-speech tagging, and dependency parsing on the generated text. The server may apply a rule-based mapping table that replaces residual strongly negative words with softer synonyms, and may enforce length limits or structural constraints. If the server detects that a generated string still contains terms from a stored list of prohibited expressions, the server can request regeneration or discard that candidate. This additional processing step reduces the risk of the generative AI model producing unsuitable content and improves the overall reliability of the system.

The server then presents either the transformed character information, the original character information, or both to the user through the terminal. When the server has produced multiple transformed candidates, the server sends these candidates together with the original character information and relevant metadata, such as a flag indicating which candidate has the lowest computed unpleasantness. The terminal displays the alternatives in a user interface that allows easy comparison, for example by showing them in a list or side-by-side. The terminal may display labels such as “Original,” “Suggestion 1,” “Suggestion 2,” and so on.

The user reviews the presented alternatives and provides an operation indicating whether to adopt one of the transformed character information strings, to adopt the original, or to edit one of the strings. The user can modify the chosen string through the input field. The terminal sends the chosen and optionally edited character information back to the server together with an indication that it is final.

The server stores the selected character information as publication data in persistent storage. The server marks the record as published and may propagate the publication data to external destinations such as content distribution services, comment feeds, or message timelines. Other terminals subsequently retrieve the publication data and display the moderated text in place of the originally submitted text. By maintaining the mapping between original and transformed character information, and by storing the associated unpleasantness and emotional state values, the server can later analyze the performance of the moderation system and retrain the models if necessary.

The server, by executing the described sequence of numerical computations, data transformations, and control decisions, improves computer technology in several ways. First, the server reduces unnecessary invocations of the generative AI model by using the unpleasantness value and emotional state thresholds as gating conditions. Because the generative AI model is computationally expensive, avoiding its use when not necessary reduces processor utilization and shortens average response time, which is a technical improvement in processing efficiency and latency.

Second, the server improves the quality and predictability of generated text by incorporating machine-computed attributes into the prompt sentence. Existing systems that send only raw text to a generative model cannot easily control the model's behavior, often requiring multiple trial-and-error generations. By contrast, the server uses structured prompt sentences that encode a target level of unpleasantness reduction and, in some embodiments, an indication of user emotion. This configuration allows the generative AI model to converge more quickly to appropriate outputs, thereby reducing the number of generation iterations and saving computation time.

Third, the server improves data management and system robustness by storing unpleasantness values, emotional states, prompt sentences, and candidate outputs in explicit data structures. This organization supports efficient indexing and retrieval, reduces redundant computation for repeated or similar comments, and facilitates model debugging and monitoring. For example, the server can analyze historical distributions of unpleasantness values to adjust thresholds dynamically, improving the balance between moderation strictness and user freedom of expression.

Fourth, the server employs neural network architectures and learning algorithms that go beyond simple automation of human moderation. The unpleasantness model and the emotion analysis model exploit complex feature interactions and high-dimensional representations that human moderators cannot compute manually. The models learn non-obvious patterns in word sequences and user behavior, enabling nuanced scoring that considers context, idioms, and user-specific factors. This capability is not a straightforward substitution of human judgment, but rather a new computational mechanism that improves classification accuracy and consistency across large volumes of data.

Fifth, the server performs integrated control of multiple models and modules (unpleasantness evaluation, emotion analysis, prompt sentence generation, generative AI model invocation, and post-processing), using explicit decision logic and thresholds. This control scheme is designed to minimize network bandwidth and computational load while maintaining high moderation quality. For example, because the generative AI model is invoked only when the numerical conditions are satisfied, and because intermediate results are cached, the system reduces overall communication with external services and lowers network congestion.

In another embodiment, the server can adapt the thresholds dynamically based on system load or observed error rates. The server can adjust the first threshold for unpleasantness upward under heavy load to reduce calls to the generative AI model, trading off strictness for performance, or adjust it downward during low load to improve moderation quality. Because these adjustments involve quantified parameters in the processing pipeline, the server can control performance characteristics in a predictable manner.

In a further embodiment, the server can use a different neural network architecture, such as a convolutional neural network that processes character-level input or a hybrid architecture combining a recurrent neural network with an attention mechanism. The server can also employ different training strategies, such as semi-supervised learning or transfer learning, where a pre-trained language model is fine-tuned on a smaller unpleasantness-labeled dataset. These variations provide alternative implementations that still fall within the scope of the claims, while allowing optimization for different hardware platforms or application domains.

In yet another embodiment, the server may operate partially on the terminal. For example, the terminal may execute a lightweight version of the unpleasantness model to perform preliminary screening, while the server executes the full pipeline including emotion analysis and generative rewriting. This arrangement reduces data transmission requirements by allowing the terminal to discard obviously harmless comments locally, and sends only borderline cases to the server for detailed processing. As a result, overall communication load and server processing demand are reduced, which is a technical effect in the communication and computing layers.

By coordinating these components and operations, the server, the terminal, and the user cooperate in a system that is not merely an abstract idea or business process, but a concrete technical solution that uses specific data structures, neural network architectures, prompt sentence generation methods, and threshold-based control logic to improve the way computing equipment processes, generates, and manages character information in an online communication environment.

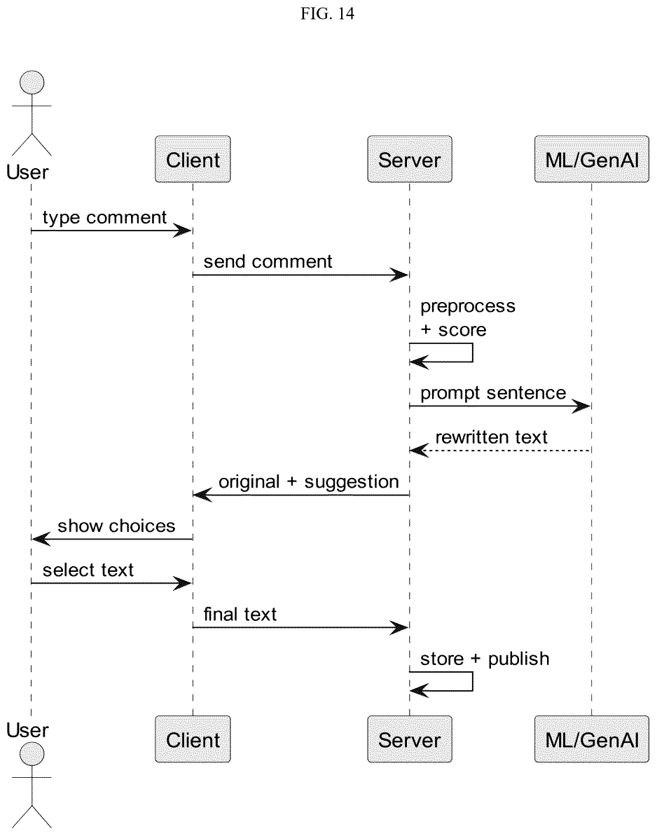

The following describes the processing flow using FIG. 14.

### Step 1:

User inputs character information on the terminal.
User types a text string, for example “This video is boring” or “This product is totally useless!∞, into an input field of an application running on the terminal, and presses a send button. The input is a raw text string and optional metadata such as a user identifier and a content identifier. The output is a structured message inside the terminal (for example an object with fields for text and metadata) that is ready to be transmitted to the server.

### Step 2:

Terminal sends the character information to the server.
Terminal packages the structured message into a request payload and transmits it to the server using a communication protocol such as HTTP or WebSocket. The input is the internal structured message created in Step 1. The output is a network request containing the text and metadata that arrives at a predefined endpoint on the server.

### Step 3:

Server receives and stores the raw character information.
Server accepts the network request, parses the payload, and extracts the text string and metadata. Server validates the presence of required fields, assigns an internal comment identifier, and writes a record into a storage system such as a relational database or a key-value store. The input is the received request data from the terminal. The output is a stored comment record containing at least the comment identifier, raw text, user identifier, and timestamps.

### Step 4:

Server preprocesses the character information into analysis data.
Server uses a natural language processing toolkit to tokenize the raw text, normalize case, remove or mark punctuation, and map each token to a numerical identifier using a shared vocabulary. Server additionally computes auxiliary features such as token positions and sequence length, and arranges them into tensors suitable for neural network input. The input is the raw text field from the stored comment record. The output is analysis data in the form of one or more tensors and feature vectors associated with the comment identifier.

### Step 5:

Server computes an unpleasantness value using a machine learning model.
Server feeds the analysis data into a trained neural network implemented with a machine learning framework, performs a forward computation, and obtains a scalar unpleasantness value and optionally a probability distribution over discrete unpleasantness classes. The neural network uses learned weights and an activation function to transform the input embeddings and features into a numeric score. The input is the analysis data tensors produced in Step 4. The output is an unpleasantness value and, where applicable, an unpleasantness class label stored in association with the comment identifier.

### Step 6:

Server estimates a user emotional state with an emotion analysis function.
Server collects emotion-related input data such as recent comments by the same user, sentiment scores of past messages, or pre-computed sensor-derived features. Server inputs these data into an emotion analysis module, which may be a separate neural network or an external sentiment analysis service, and calculates emotion scores such as anger, calmness, or stress intensities. The input is user-related historical and contextual data retrieved from storage. The output is an emotional state representation, for example a vector of emotion scores and an emotion label, linked to the comment identifier.

### Step 7:

Server determines whether transformation is required based on thresholds.
Server compares the unpleasantness value against a predefined unpleasantness threshold and compares an emotion intensity score (for example anger) against an emotional threshold. Server evaluates logical conditions such as “unpleasantness≥threshold1 AND anger≥threshold2” to decide whether the comment is a target for transformation. The input is the unpleasantness value from Step 5 and the emotional state from Step 6. The output is a decision flag indicating either “transform” or “do not transform,” which is stored as a field in the comment record.

### Step 8:

Server generates a prompt sentence when transformation is required.
Server checks the decision flag and, when the flag indicates “transform,” constructs a prompt sentence by inserting the original text and optionally the unpleasantness value or emotion label into an instruction template. For example, the server may generate:
“Rewrite the following user comment into a wording with a lower degree of unpleasantness while preserving its meaning: ‘This video is boring.’”
or
“User comment: ‘This product is totally useless!’ Please generate an alternative expression that is less offensive but keeps the user's opinion.”
The input is the original text, the unpleasantness value, and possibly the emotional state. The output is a prompt sentence string that encodes both the text content and transformation requirements.

### Step 9:

Server calls the generative AI model with the prompt sentence.
Server sends the prompt sentence to a generative AI model implemented locally or accessed via a network API. Server specifies generation parameters such as maximum number of tokens, sampling temperature, and number of alternative outputs. The generative AI model processes the prompt sentence using its internal neural network architecture and produces one or more transformed text candidates. The input is the prompt sentence from Step 8 and the generation parameters. The output is one or more transformed character information strings returned to the server.

### Step 10:

Server post-processes the transformed character information.
Server parses each generated string to remove extraneous quotation marks, leading instructions, or incomplete sentences. Server may apply additional natural language processing to detect residual strong negative words and to enforce maximum length and formatting rules. If any candidate violates moderation rules, server can discard or regenerate that candidate. The input is the raw outputs from the generative AI model in Step 9. The output is a cleaned list of candidate transformed character information strings associated with the original comment.

### Step 11:

Server selects information to present to the user.
Server decides which text versions to send back to the terminal. When transformation was required, server typically selects the best transformed candidate, for example the first candidate or the candidate with the lowest estimated unpleasantness, and may also include the original text for comparison. When transformation was not required, server selects only the original text. The input is the decision flag from Step 7, the original text, and the cleaned candidate strings from Step 10. The output is a response payload containing one or more text alternatives and metadata indicating which alternatives are suggestions.

### Step 12:

Terminal receives and displays the alternatives.
Terminal accepts the response payload from the server, parses the included text alternatives, and renders them in the graphical user interface. Terminal may show the original character information and one or more suggestions labeled, for example, “Original,” “Suggestion 1,” and “Suggestion 2.” The input is the response payload from Step 11. The output is a visual presentation on the terminal screen that allows the user to view each alternative.

### Step 13:

User selects, accepts, or edits a text alternative.
User reads the displayed texts and chooses one version to adopt by tapping or clicking on a corresponding control. Alternatively, user may edit one of the suggestions directly in the input field to adjust nuances. The input is the displayed texts from Step 12. The output is a final chosen text string and an action indication (for example “accept suggestion,” “use original,” or “edited text”) held within the terminal.

### Step 14:

Terminal sends the final chosen text to the server for publication.
Terminal packages the final chosen text and the associated comment identifier into a request and transmits it to a publication endpoint on the server. The input is the user-selected or edited text from Step 13. The output is a network message carrying the finalized character information and status to the server.

### Step 15:

### Server Registers and Outputs the Publication Data.

Server receives the final text, updates the corresponding comment record to store the final version as publication data, and marks its status as published. Server then makes the publication data available to external systems, for example by inserting it into a comment list for a piece of content or by providing it through an application programming interface. The input is the finalized character information from Step 14. The output is a stored publication record and an externally accessible representation of the moderated comment that other terminals can retrieve and display.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

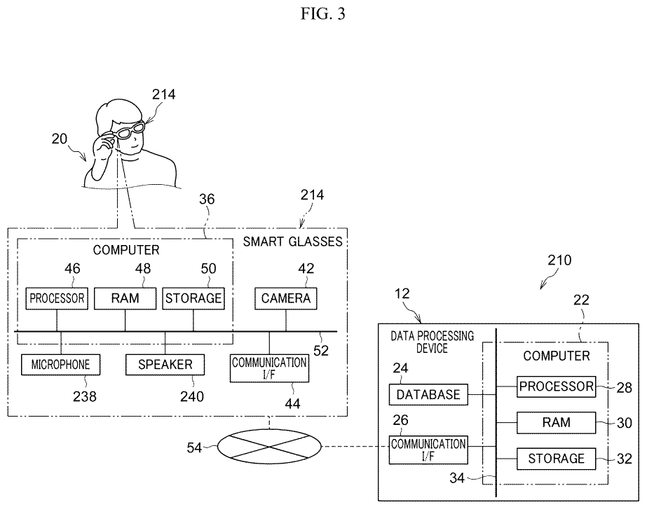

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

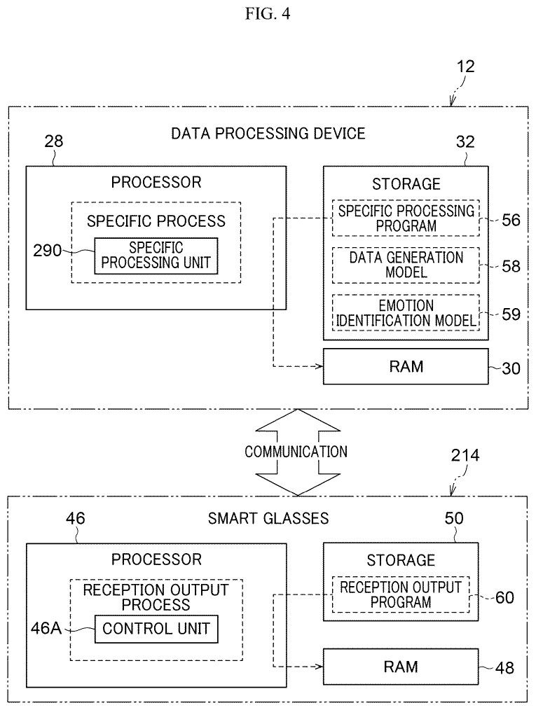

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

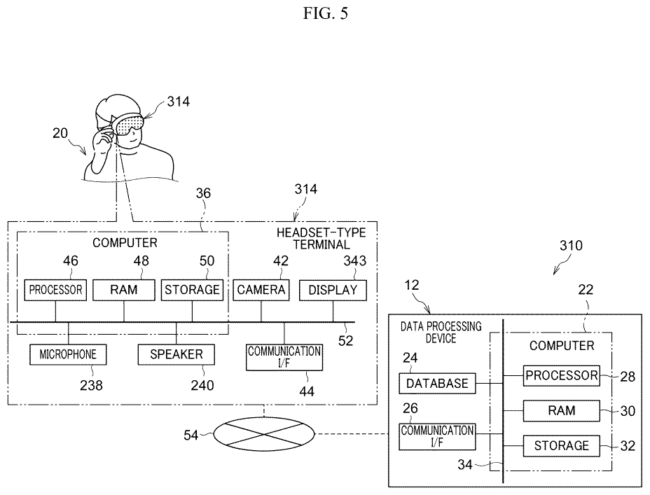

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

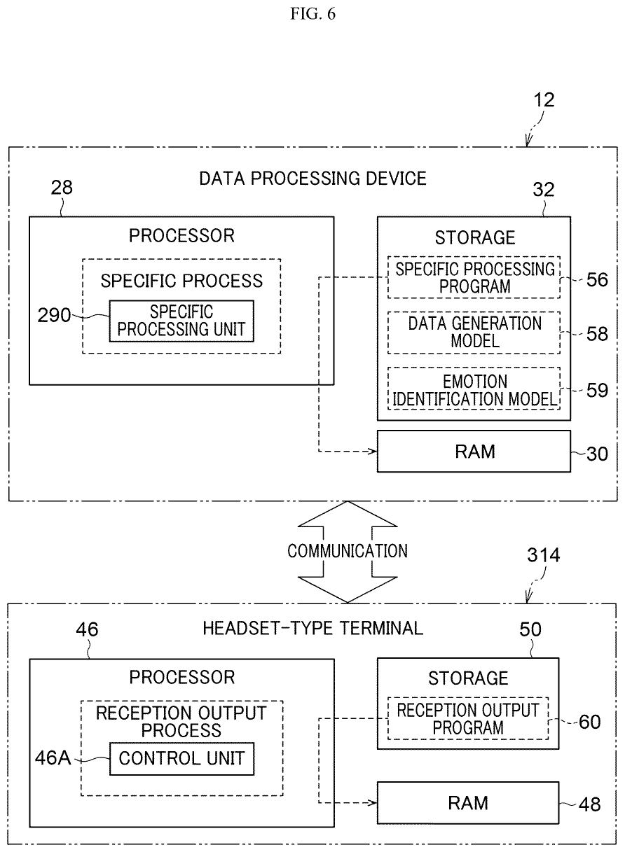

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

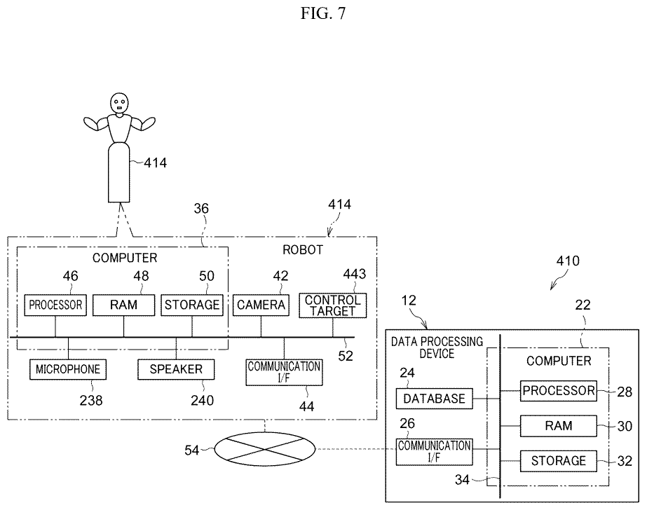

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

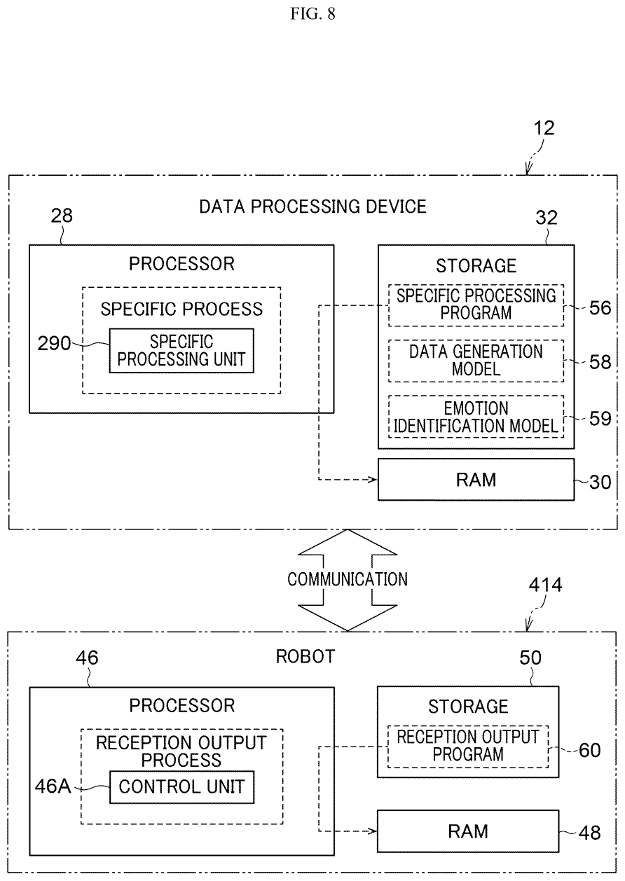

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

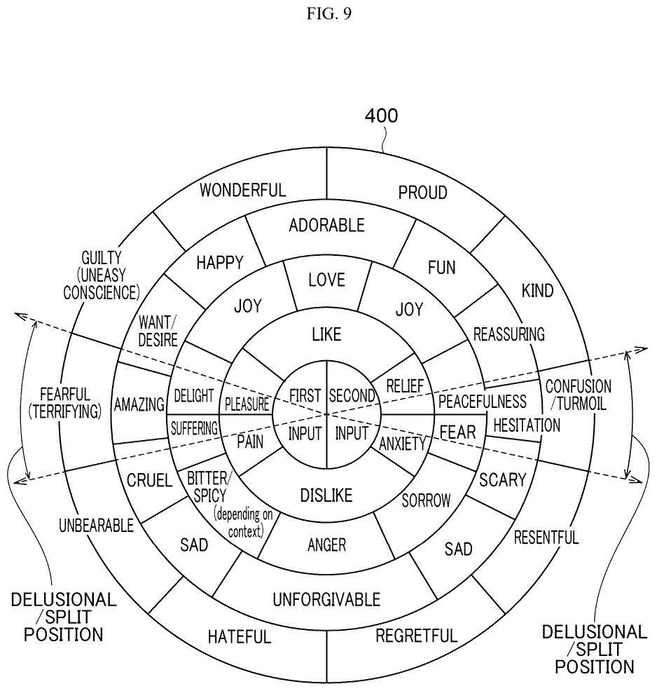

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

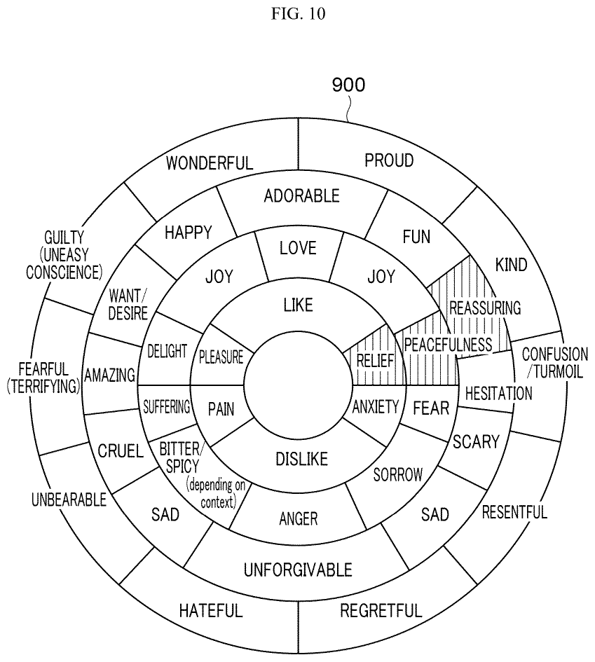

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, a storage device, a communication interface, and a user interface,
wherein the processor is configured to
receive character information transmitted from a user terminal via a communication network through the communication interface, store the character information in the storage device, and present the character information in an input region of a display screen of the user interface,
perform, on the character information stored in the storage device, a preprocessing operation including at least string normalization and word segmentation, and calculate, by using a trained machine learning model, a numerical score representing a discomfort level of the character information based on the preprocessed character information,
compare the numerical score with a predetermined threshold value, and determine whether the character information is required to be rewritten when the numerical score exceeds the predetermined threshold value,
generate, when it is determined that the numerical score exceeds the predetermined threshold value, a prompt sentence including the character information and instruction content for reducing the discomfort level, input the prompt sentence to a generative artificial intelligence model as a generative AI model, and cause the generative artificial intelligence model to perform a natural language generation process to generate transformed character information in which the discomfort level is reduced while semantic content of the character information is maintained,
select, when it is determined that the numerical score is equal to or less than the predetermined threshold value, the character information without transformation as presentation character information, select, when it is determined that the numerical score exceeds the predetermined threshold value, the transformed character information as the presentation character information, transmit the presentation character information to the user terminal via the communication interface, and store the presentation character information in the storage device as associated information, and
store, as log information in the storage device, at least a result of the calculation of the numerical score and the prompt sentence and a generated result in the natural language generation process, and execute, periodically or under a predetermined condition, an update process of retraining the trained machine learning model based on the log information and the numerical score.

### (Supplementary 2)

The system according to supplementary 1,
wherein the processor is configured to, when the numerical score exceeds the predetermined threshold value, generate the prompt sentence including the character information as a quoted portion and an instruction to rewrite the quoted portion so as to reduce the discomfort level while maintaining core semantic content, input the prompt sentence to the generative artificial intelligence model, and acquire, from the generative artificial intelligence model, the transformed character information generated based on the prompt sentence.

### (Supplementary 3)

The system according to supplementary 1,
wherein the processor is configured to, when the numerical score is equal to or less than the predetermined threshold value, select the character information itself as the presentation character information, and when the numerical score exceeds the predetermined threshold value, select only the transformed character information as posting information to be presented to another user and transmit the transformed character information to the user terminal via the communication interface.

### Application Example 1

### (Supplementary 1)

A system comprising a processor,
wherein the processor is configured to
receive user information from a terminal device and acquire the user information as character information,
preprocess the character information to convert the character information into structured information in units of words or sentences and generate a numerical vector based on the structured information, and quantify a discomfort level of the character information using the numerical vector to output an evaluation result,
generate first candidate information for the character information determined to have a high discomfort level on the basis of the evaluation result by performing replacement processing using dictionary information and rule information, generate a prompt sentence including the first candidate information and the character information, operate a generative artificial intelligence model using the prompt sentence as input to generate second candidate information in which the discomfort level is reduced, and perform re-evaluation of the discomfort level with respect to the second candidate information to confirm that the discomfort level is within a predetermined range and thereby determine the second candidate information as converted information, and
transmit the converted information or the character information to the terminal device to present the converted information or the character information on the terminal device, accept an approval input or a correction input from a user, and, in response to the approval input, store the converted information or the character information as publication information and make the publication information retrievable from another terminal device.

### (Supplementary 2)

The system according to supplementary 1,
wherein the processor is configured to
input the numerical vector into a machine learning model to obtain a discomfort score, compare the discomfort score with a predetermined threshold, convert the character information into the converted information when the discomfort score is equal to or greater than the predetermined threshold, and present the character information without conversion when the discomfort score is less than the predetermined threshold.

### (Supplementary 3)

The system according to supplementary 1,
wherein the processor is configured to
receive partial character information that is being input and is sequentially transmitted from the terminal device, sequentially execute evaluation of the discomfort level with respect to the partial character information, and, on the basis of the evaluation result, generate a candidate of an uncomfortable expression and a candidate of an alternative expression in the partial character information as the converted information and present the candidates to the terminal device in real time.

### Example 2

### (Supplementary 1)

A system comprising a processor,
wherein the processor is configured to
receive character information from a user terminal, convert the character information into feature values and execute a classification model to calculate an unpleasantness level of the character information as a numerical value, compare the calculated unpleasantness level with a predetermined threshold to determine whether the character information is to be a conversion target,
when it is determined that the character information is the conversion target, generate a prompt sentence including the character information, transmit the prompt sentence to an external generative information processing apparatus, and obtain response information including character information with a reduced unpleasantness level from the external generative information processing apparatus to thereby convert the character information, store, in a storage device, the calculated unpleasantness level, the threshold for the unpleasantness level, converted character information obtained by the conversion, and attribute information indicating whether conversion has been performed in association with one another, and
generate output information including either the character information or the converted character information according to a result of the determination and transmit the output information to the user terminal via a communication path.

### (Supplementary 2)

The system according to supplementary 1,
wherein the processor is configured to
calculate the unpleasantness level of the character information by using a statistical learning model that has been trained based on past character information and training data indicating unpleasantness levels associated with the past character information, and, when the calculated unpleasantness level is equal to or greater than the threshold, generate the prompt sentence and transmit the prompt sentence to the external generative information processing apparatus.

### (Supplementary 3)

The system according to supplementary 1,
wherein the processor is configured to
when the calculated unpleasantness level is less than or equal to the threshold, transmit the character information to the user terminal as the output information without conversion, and when the calculated unpleasantness level exceeds the threshold, transmit the converted character information obtained by the conversion to the user terminal as the output information.

### Application Example 2

### (Supplementary 1)

A system comprising a processor,
wherein the processor is configured to
receive character information from a user via an input/output interface, preprocess the character information to generate analysis data,
input the analysis data into a machine learning model and calculate an unpleasantness value of the character information as a numerical score,
estimate an emotional state of the user by using an emotion analysis function and, based on the unpleasantness value and the emotional state, determine whether the character information is to be a target for transformation,
when the character information is determined to be the target for transformation, generate a prompt sentence including content of the character information and the unpleasantness value by using natural language processing, input the prompt sentence into a generative AI model, and generate transformed character information having a lower unpleasantness level by natural language generation,
when the character information is determined not to be the target for transformation, retain the character information without transformation, and cause at least one of the transformed character information and the untransformed character information to be presented to the user, and
accept an operation from the user regarding adoption or editing of character information presented to the user, and, based on a result of the operation, store the character information or the transformed character information as publication data and output the publication data to an external destination.

### (Supplementary 2)

The system according to supplementary 1,
wherein the processor is configured to, when the unpleasantness value is equal to or greater than a first threshold and an intensity of the emotional state is equal to or greater than a predetermined emotional intensity, execute generation of the transformed character information by using the generative AI model, and, when the unpleasantness value is less than the first threshold and the intensity of the emotional state is less than the predetermined emotional intensity, present the character information to the user without transformation.

### (Supplementary 3)

The system according to supplementary 1,
wherein the processor is configured to generate the prompt sentence including the unpleasantness value and information representing the emotional state, input the prompt sentence into the generative AI model to generate a plurality of types of transformed character information, present the plurality of types of transformed character information together with the character information to the user, and register, as the publication data, only character information selected or edited by the user.

What is claimed is:

1. A system comprising:
circuitry configured to:
receive, via a communication interface coupled to a packet-switched network, character information from a terminal device, store the character information in a storage device, and perform preprocessing on the character information including string normalization and word segmentation to generate preprocessed character information;
convert the preprocessed character information into a numerical vector and input the numerical vector into a trained machine learning model to calculate a numerical score representing a discomfort level of the character information;
compare the numerical score with a predetermined threshold value to determine whether rewriting of the character information is required;
when the numerical score exceeds the predetermined threshold value, generate a prompt sentence including the character information and instruction content for reducing the discomfort level, and input the prompt sentence to a generative neural network model to generate transformed character information in which the discomfort level is reduced while semantic content of the character information is maintained;
select presentation character information by choosing the character information when the numerical score is equal to or less than the predetermined threshold value, and by choosing the transformed character information when the numerical score exceeds the predetermined threshold value; and
transmit the presentation character information to the terminal device via the communication interface, store the presentation character information in the storage device as associated information, and store, as log information, at least the numerical score, the prompt sentence, and a generation result of the generative neural network model.

2. The system according to claim 1, wherein the circuitry is configured to re-evaluate the discomfort level with respect to the transformed character information by recomputing the numerical score using the trained machine learning model, and confirm that the numerical score for the transformed character information is within a predetermined range before selecting the transformed character information as the presentation character information.

3. The system according to claim 2, wherein the circuitry is configured to generate first candidate information for the character information determined to exceed the predetermined threshold value by performing replacement processing using dictionary information and rule information, and generate the prompt sentence including the first candidate information and the character information such that the generative neural network model generates second candidate information having a further reduced discomfort level.

4. The system according to claim 3, wherein the circuitry is configured to accept an approval input or a correction input from a user via the terminal device, and in response to the approval input, store the transformed character information or the character information as publication information in the storage device.

5. The system according to claim 4, wherein the circuitry is configured to receive a correction input from the user via the terminal device, update the transformed character information based on the correction input, and store the updated transformed character information as the publication information.

6. The system according to claim 1, wherein the circuitry is configured to periodically or conditionally execute model update processing using the log information stored in the storage device, to retrain or update the trained machine learning model based on accumulated log data.

7. The system according to claim 6, wherein the circuitry is configured to apply learning data including the numerical score, the prompt sentence, and the generation result of the generative neural network model as training examples in the model update processing to improve accuracy of the trained machine learning model.

8. The system according to claim 1, wherein the circuitry is configured to convert the character information into structured information in units of words or sentences using the preprocessing, generate the numerical vector from the structured information using a feature extraction function, and input the numerical vector into the trained machine learning model to obtain the discomfort score as a floating-point output.

9. The system according to claim 8, wherein the circuitry is configured to apply a transformer-based language model to the character information to generate a contextual embedding vector, and use the contextual embedding vector as the numerical vector input to the trained machine learning model.

10. The system according to claim 1, wherein the circuitry is configured to receive character information from the terminal device as audio information and execute speech recognition processing on the audio information to generate the character information prior to performing the preprocessing.

11. The system according to claim 10, wherein the circuitry is configured to apply emotion analysis processing to at least one of the audio information and the character information to estimate an emotional state of a user, and incorporate the estimated emotional state into the instruction content of the prompt sentence to adjust a tone of the transformed character information.

12. The system according to claim 11, wherein the circuitry is configured to store the estimated emotional state in the log information in association with the numerical score and the generation result, and use the stored emotional state data in the model update processing.

13. The system according to claim 1, wherein the circuitry is configured to convert the character information into feature values and execute a trained statistical learning model to calculate an unpleasantness level of the character information as a numerical value, compare the unpleasantness level with a predetermined threshold to determine whether the character information is a conversion target, and store the unpleasantness level, the threshold, the converted character information, and attribute information indicating whether conversion has been performed in association with one another in the storage device.

14. The system according to claim 13, wherein the circuitry is configured to generate output information including either the character information or the converted character information according to a result of the determination and transmit the output information to the terminal device via the communication interface.

15. The system according to claim 1, wherein the circuitry is configured to present the character information in an input region of a user interface on the terminal device prior to performing the preprocessing, and update the presentation in the user interface with the presentation character information after processing.

16. The system according to claim 15, wherein the circuitry is configured to display, in the user interface, an indication of whether the character information was transformed, and provide the user with an option to view the original character information and the transformed character information side by side.

17. The system according to claim 1, wherein the circuitry is configured to accumulate the log information including numerical scores, prompt sentences, and generation results in the storage device, and periodically analyze the accumulated log information to detect systematic patterns in content that exceeds the predetermined threshold value.

18. A system comprising:
circuitry configured to:
receive, via a communication interface coupled to a packet-switched network, character information from a terminal device, and perform preprocessing on the character information including string normalization and word segmentation to generate preprocessed character information;
convert the preprocessed character information into a numerical vector and input the numerical vector into a trained machine learning model to calculate a numerical score representing a discomfort level;
compare the numerical score with a predetermined threshold value, and when the numerical score exceeds the predetermined threshold value, generate first candidate information by applying replacement processing using dictionary information and rule information to the character information;
generate a prompt sentence including the first candidate information and the character information, input the prompt sentence to a generative neural network model to generate second candidate information with a further reduced discomfort level, and re-evaluate the discomfort level of the second candidate information using the trained machine learning model to confirm the discomfort level is within a predetermined range;
select presentation character information by choosing the character information when the numerical score is equal to or less than the threshold, and by choosing the second candidate information when the numerical score exceeds the threshold and the re-evaluation confirms the discomfort level is within the predetermined range; and
transmit the presentation character information to the terminal device via the communication interface, and store the numerical score, the prompt sentence, and the generation result in a storage device as log information.

19. The system according to claim 18, wherein the circuitry is configured to periodically execute model update processing using the log information to retrain the trained machine learning model, using accumulated log data including the numerical score, the prompt sentence, and the generation result as training examples.

20. A method comprising:
receiving, via a communication interface coupled to a packet-switched network, character information from a terminal device, storing the character information in a storage device, and performing preprocessing on the character information including string normalization and word segmentation to generate preprocessed character information;
converting the preprocessed character information into a numerical vector and inputting the numerical vector into a trained machine learning model to calculate a numerical score representing a discomfort level of the character information;
comparing the numerical score with a predetermined threshold value to determine whether rewriting of the character information is required;
when the numerical score exceeds the predetermined threshold value, generating a prompt sentence including the character information and instruction content for reducing the discomfort level, and inputting the prompt sentence to a generative neural network model to generate transformed character information in which the discomfort level is reduced while semantic content of the character information is maintained;
selecting presentation character information by choosing the character information when the numerical score is equal to or less than the predetermined threshold value, and by choosing the transformed character information when the numerical score exceeds the predetermined threshold value; and
transmitting the presentation character information to the terminal device via the communication interface, storing the presentation character information in the storage device, and storing, as log information, at least the numerical score, the prompt sentence, and a generation result of the generative neural network model.
